(19) United States
(12) Patent Application Publication
(10) Pub. No.: US 2026/0257445 A1
(43) Pub. Date: Sep. 3, 2026

(54) Recycling System and method for Manual Smashing of Containers with Computer Vision-Based Operation Monitoring and User Crediting

(71) Applicant: Rafi Ziv, Ramat Gan (IL)

(72) Inventor: Rafi Ziv, Ramat Gan (IL)

(21) Appl. No.: 19/553,480

(22) Filed: Mar. 2, 2026

Related U.S. Application Data
(60) Provisional application No. 63/764,662, filed on Feb. 28, 2025.

(51) Int. Cl. B30B 15/00; G06Q 10/30; G06Q 30/0207

(52) U.S. Cl. CPC B30B 15/0094; G06Q 10/30; G06Q 30/0207

(57) ABSTRACT

A computer vision-enabled recycling system facilitates the disposal of one or more containers of any recyclable material through a manual compression mechanism integrated with a recycling receptacle featuring a designated insertion aperture. A camera processor, interfaced with a cloud- based computational unit, captures image sequences of the compression process. A computer vision algorithm processes these sequences to detect the state transitions of the compression mechanism, from an open to a closed position, isolates relevant image frames, and classifies the compressed object as an eligible container, a non-eligible container, or background using machine learning-based image recognition techniques. The system further verifies the insertion of the classified object into the receptacle. A data aggregation processor logs validated recycling events and assigns user-specificcredits accordingly. By integrating image-based classification, mechanical processing, and cloud- driven analytics, the system enhances recycling efficiency, object classification accuracy, and user participation tracking within waste management infrastructures.

### CROSS-REFERENCE TO RELATED APPLICATIONS

This application is a U.S. Non-Provisional Utility Patent Application which claims priority to co-pending U.S. Provisional Patent Application No. 63/764,662, filed on February 28, 2025 the contents of which are hereby fully incorporated by reference.

### FIELD OF THE EMBODIMENTS

The field of the invention and its embodiments relate to computer vision-based recycling systems, incorporating elements of recycling technology, image processing, and user incentive systems. Specifically, the system combines mechanical recycling tools with cloud-based Al processing, placing it at the intersection of multiple technical domains. These include mechanical engineering for the crushing mechanisms, computer vision for image-based classification, and user incentive systems for credit tracking and reporting.

### BACKGROUND OF THE EMBODIMENTS

Effective waste management and material recovery rely on accurate tracking and verification of recycling activities. Conventional recycling systems often depend on manual input, such as user- reported counts or weight-based assessments, which introduce significant errors. Self-reporting mechanisms lack verification, leading to potential misrepresentation of recycling actions, while weight-based approaches cannot distinguish between properly processed and improperly disposed materials. These limitations compromise data integrity and reduce the effectiveness of incentive- driven recycling programs configured to encourage user participation.

Additionally, proper preprocessing of recyclable materials, such as crushing plastic bottles and aluminum cans, is essential for optimizing storage, transport, and sorting efficiency. However, conventional systems lack automated methods to confirm whether users have performed these preprocessing steps correctly. As a result, unprocessed or contaminated materials may enter the recycling stream, increasing operational costs, reducing material recovery rates, and complicating downstream sorting processes. The absence of a robust monitoring framework further impairs efforts to standardize user compliance with recycling protocols.

Current incentive-based recycling programs struggle to maintain user engagement due to inefficiencies in tracking individual contributions. While some systems utilize deposit return schemes or point-based incentives, they typically require centralized collection points and manual validation, which create barriers to participation. The inability to automatically detect and classify user actions in real time limits the scalability and effectiveness of these programs. An advanced system capable of real-time monitoring, verification, and classification of recycling actions is necessary to enhance operational accuracy, improve material processing efficiency, and sustain user engagement through automated credit allocation.

### SUMMARY OF THE EMBODIMENTS

The system provides an integrated recycling system configured to automate and verify the recycling of one or more containers of any recyclable material, such as metal, plastic, and/or glass. The system includes a manual smashing tool that is capable of crushing one or more containers, with distinct open and closed states. It also features a recycle bin with a specially shaped aperture to accept the properly smashed materials. A camera processor is positioned to capture video footage of the smashing operation, while a cloud-connected processing system runs a computer vision algorithm to monitor and analyze the recycling process. The algorithm detects transitions of the manual smasher from open to closed, retrieves and crops corresponding video frames, and classifies the objects as eligible bottles, eligible cans, non-eligible bottles, or background. The system includes a reporting and credit processor that aggregates verified recycling operations, generating reports and awarding credits to users based on their verified actions. This automated system ensures accurate recycling verification, enhances operational efficiency, and encourages sustainable behavior through an incentivized credit system.

In some aspects, the techniques described herein relate to a recycling system for one or more containers including: a compression apparatus configured to receive and deform a container, the compression apparatus including a compression member movable between an open configuration permitting insertion of the container and a closed configuration applying compressive force to the container; a recycle bin including an insertion aperture configured to receive a deformed container; a sensor, such as a camera, may be implemented in any device, such as a mobile device, a smart phone, and/or a tablet, configured to capture video images of one or more compression operations; and a cloud-connected processing system including a computer vision algorithm configured to: detect transitions of the compression apparatus from the open configuration to the closed configuration; capture and crop video frames corresponding to the closed configuration; and classify the cropped image as representing an eligible container, a non-eligible container, or background; and a reporting processor configured to aggregate validated recycling operations and award user credits based on a count of such operations.

In some aspects, the techniques described herein relate to a method for recycling one or more containers, including: receiving a container into a compression apparatus having an open configuration and a closed configuration; moving a compression member of the compression apparatus from the open configuration to the closed configuration to deform the container; capturing video images of the deformation using a sensor; transmitting the video images to a cloud-connected processing system; detecting, using a computer vision algorithm, a transition from the open configuration to the closed configuration; capturing and cropping a video frame corresponding to the closed configuration; classifying the cropped image as representing an eligible container, a non- eligible container, or background; detecting insertion of the deformed container into a recycle bin; and generating a report of validated recycling operations and awarding user credits denominated in NIS, which refers to New Israeli Shekels, based on one or more validated operations.

In some embodiments, the monetary credits may be denominated in a currency other than NIS, including but not limited to U.S. Dollars (USD), Euros (EUR), British Pounds (GBP), or other local or digital currencies supported by the system. The denomination of credits may be determined based on the geographic location of the recycling station, user account settings, regulatory requirements, or program-specific configurations. In certain embodiments, credits may be issued in the form of reward points, digital tokens, vouchers, or other units of value that may be redeemed for goods, services, discounts, or financial compensation. The system may further support currency conversion based on prevailing exchange rates at the time of credit issuance or redemption. In some implementations, credits may be stored within a digital wallet associated with the user account. This flexibility enables the recycling system to operate across multiple jurisdictions and incentive programs.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating a recycling system, according to some embodiments.

FIG. 2A is a flowchart illustrating a method for recycling one or more containers of any recyclable material, such as metal, plastic, and/or glass, according to some embodiments.

FIG. 2B is a flowchart extending from FIG. 2A and further illustrating the method for recycling one or more containers of any recyclable material, such as metal, plastic, and/or glass, according to some embodiments.

FIG. 3 illustrates an example of computer vision detecting a manual smasher retaining a container, monitoring an opening of a recycle bin for activity related to receiving a smashed container, according to some embodiments.

FIG. 4 is a block diagram of the manual smashing tool of the recycling system from FIG. 3, according to some embodiments.

FIG. 5 illustrates a system architecture for a computer vision-enabled recycling verification system, according to some embodiments.

FIG. 6 illustrates a process flow architecture for session initiation, recording, algorithmic scoring, and human verification within a recycling validation system, according to some embodiments.

FIG. 7 is a block diagram further illustrating the recycling system from FIG. 8, according to some embodiments.

FIG. 8 is a block diagram illustrating a recycling system, according to some embodiments of the present disclosure.

FIG. 9 is a block diagram further illustrating the recycling system from FIG. 8, according to some embodiments.

FIG. 10A is a flowchart illustrating a method for recycling one or more containers, according to some embodiments.

FIG. 10B is a flowchart extending from FIG. 10A and further illustrating the method for recycling one or more containers, according to some embodiments.

FIG. 11 is a flowchart further illustrating the method for recycling one or more containers from FIG. 10A, according to some embodiments.

FIG. 12 is a flowchart further illustrating the method for recycling one or more containers from FIG. 10A, according to some embodiments.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

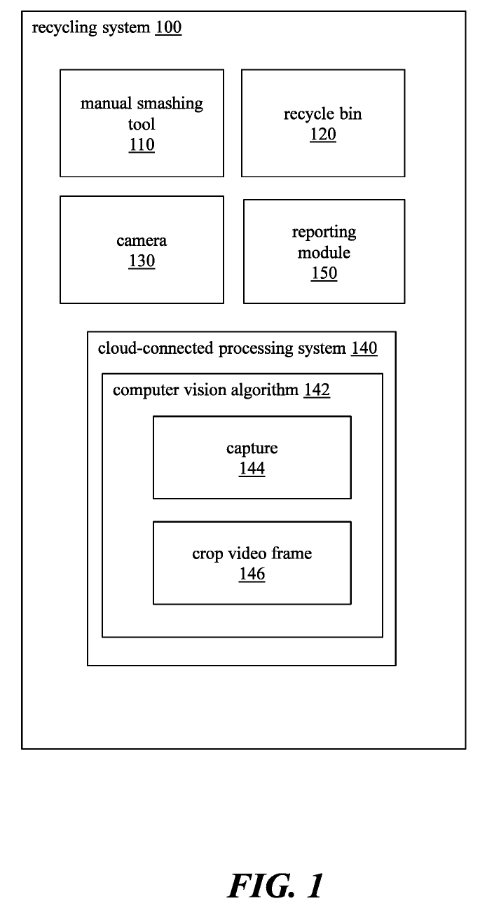

FIGS. 1-12 illustrate example systems and methods of implementing recycling management using integrated hardware and software components. It includes a manual smashing tool, a sensor such as a camera that may be implemented in any device such as a mobile device, a smart phone, and/or a tablet for capturing video of one or more recyclables, and a central processing unit that analyzes the collected data. The process begins with the placement of a recyclable item into the smashing tool and recycle container, followed by video capture for classification. A recyclable item includes, but is not limited to, a container such as a can, a bottle, and/or a non-eligible can. Machine learning algorithms then sort the materials into recyclable and non-recyclable categories. Real-time feedback is provided to users through an interface that tracks recycling actions and rewards progress. Additionally, the system connects to a cloud platform for monitoring and data synchronization. This setup aims to streamline the recycling process, enhance accuracy, and offer engaging user feedback to promote recycling efforts.

As used herein, the term "non-eligible container" refers to any bottle, can, or other container that does not satisfy one or more predefined validation criteria required for classification as an eligible recyclable container within the system. In some embodiments, a non-eligible container may include a bottle or can that is not marked in accordance with a Deposit Return Scheme designation such as "Required Return." In some embodiments, a non-eligible container may include containers that are outside the scope of a regulated return program, including containers that lack approved markings, labels, barcodes, or identifiers indicating eligibility for deposit-based recycling. In some embodiments, a non-eligible container may include a container that is not composed of an approved recyclable material or that is formed from mixed materials not processable within a designated recycling stream. In some embodiments, a non-eligible container may include a bottle or can that has not been properly crushed or deformed by the compression apparatus prior to insertion into the recycle bin. In some embodiments, a non-eligible container may include a contaminated container containing foreign material, liquid, hazardous substances, or residual contents exceeding a predetermined threshold.

In some embodiments, a non-eligible container may include a structurally deformed bottle or can that does not conform to geometric parameters associated with standard deposit-eligible containers, such as diameter, height, wall thickness, neck profile, rim structure, or base configuration. In some embodiments, a non-eligible container may include a container that visually resembles a recyclable bottle or can but is not registered within an approved deposit return system. In certain embodiments, classification of a non-eligible container is determined by a computer vision algorithm trained to identify visual features inconsistent with validated recyclable containers, including absence of Required Return markings, labeling inconsistencies, contamination indicators, material characteristics, or improper deformation patterns. In some embodiments, a non-eligible container is excluded from credit allocation and may be logged separately for reporting, compliance verification, or user feedback purposes.

As used herein, the term "container" refers to any vessel, receptacle, or enclosed structure configured to hold, store, transport, or dispense a substance, material, or product. In some embodiments, a container may include a beverage container such as a bottle or a can. In some embodiments, a container may be formed from metal, aluminum, steel, plastic, polyethylene terephthalate (PET), polypropylene (PP), high-density polyethylene (HDPE), glass, composite materials, multilayer materials, or combinations thereof. In some embodiments, a container may include a generally cylindrical, prismatic, or irregular shape and may include structural features such as a sidewall, base, rim, neck, opening, closure interface, pull tab, cap interface, and/or label region.

In some embodiments, the term container includes both eligible recyclable containers and non- eligible containers, as determined by predefined material, geometric, or processing criteria. In some embodiments, a container may be empty, partially filled, or contaminated. In certain embodiments, the container is configured to be mechanically deformed, crushed, compressed, or otherwise reduced in volume by the manual smashing tool prior to insertion into the recycle bin. The term container is intended to be interpreted broadly and is not limited to any specific material composition, size, or commercial use unless explicitly stated.

FIG. 1 illustrates a block diagram of a recycling system 100, according to some embodiments of the present disclosure. The recycling system 100 includes a recycle bin 120 with an insertion aperture configured to receive smashed material, a sensor such as a camera 130 that may be implemented in any device such as a mobile device, a smart phone, and/or a tablet for capturing video images of one or more smashing operations, a cloud-connected processing system 140, and a reporting processor 150 that aggregates validated recycling operations and awards user credits based on the number of operations performed. The system also includes a manual smashing tool 110 configured to receive and crush a bottle or can of any recyclable material such as metal, plastic, and/or glass, with the tool capable of transitioning between an open and a closed configuration.

In some embodiments, the cloud-connected processing system 140 includes a computer vision algorithm 142 that detects transitions of the manual smashing tool 110 from the open to the closed state. The computer vision algorithm is configured to capture 144 and to crop 146 video frames corresponding to the closed state of the smashing tool and classifies the cropped image into categories such as eligible bottle, eligible can, non-eligible bottle, or background.

In some embodiments, the computer vision algorithm may incorporate machine learning techniques to improve the accuracy of the classification process. Additionally, mechanical sensors may be integrated into the manual smashing tool 110 to assist in detecting the open and closed states. The processing system 140 may also detect when a smashed object is inserted into the recycle bin 120 and associate this action with the classification result. The reporting processor 150 may include a user interface that displays, in real time, the number of validated recycling operations and the credits awarded to the user.

In some embodiments, the recycling system is configured such that the system itself does not differentiate between container material types prior to processing. Instead, differentiation between container categories is performed by the user through physical placement of the container at a designated panel or processing station corresponding to a selected container type. In certain embodiments, the system may include a plurality of physically distinct panels, stations, or zones, each associated with a particular container category, such as aluminum cans, plastic bottles, glass containers, or other recyclable materials. Each panel may include a corresponding manual smashing tool and/or insertion aperture that is mechanically configured for a particular container type. The system may rely on user selection and placement of the container at the appropriate panel to determine the intended classification category.

In such embodiments, the computer vision algorithm is not required to distinguish between different material compositions or container types based solely on image-based material recognition. Instead, the classification logic may operate under the assumption that containers placed at a given panel belong to the designated category for that panel. The algorithm may therefore focus on validating whether a container is present, whether it has been properly crushed, and whether it has been correctly inserted into the associated recycle bin aperture, rather than determining the material type. In some embodiments, each panel may include visual indicators, labeling, color coding, lighting cues, digital prompts, and/or app-based guidance instructing users where to place specific container types. For example, a first panel may be labeled for aluminum cans, while a second panel may be labeled for plastic bottles. In some embodiments, the mobile application may prompt the user to select a container category prior to initiating a recycling event, and the system may verify that the detected smashing operation corresponds to the selected panel.

In certain embodiments, the processing system may associate a panel identifier with each detected smashing event. The panel identifier may be determined based on a sensor and/or a camera field-of-view segmentation, positional detection of the manual smashing tool, embedded panel- specific sensors, QR markers, fiducial markers, or predefined region-of-interest coordinates corresponding to each panel. The classification result may therefore be derived from the combination of (i) detected smashing operation and (ii) panel location, rather than from direct material recognition.

In some embodiments, this architecture reduces computational complexity by eliminating the need for fine-grained material differentiation within the computer vision classifier while simultaneously supporting market education for sustainability and encouraging consumer source segregation. Instead of requiring the system to determine detailed material composition, the classifier may be trained to detect eligible container geometry and proper deformation state, while users are guided to place containers into designated collection paths based on material type or deposit eligibility. This approach reinforces responsible sorting behavior at the point of disposal and promotes awareness of recycling practices among consumers. By combining system-level validation with user-driven segregation, the architecture supports broader sustainability goals beyond automated classification alone. This design may improve processing speed and reduce model size in environments with variable lighting or reflective surfaces. It also enables the system to serve as an educational tool that encourages correct recycling behavior without increasing computational burden.

In certain implementations, the system may still detect non-eligible objects placed at a panel, such as objects that do not conform to expected container geometry, even if the material category is user-designated. If a container is placed at an incorrect panel, the system may optionally generate a notification, reject credit allocation, or flag the event for review. This embodiment enables a hybrid human-assisted classification architecture, wherein users perform primary material segregation and the system performs mechanical validation, image-based confirmation of container presence, crushing verification, and insertion verification. By combining user-driven sorting with automated validation, the system maintains accuracy in incentive allocation while reducing algorithmic burden and increasing operational scalability.

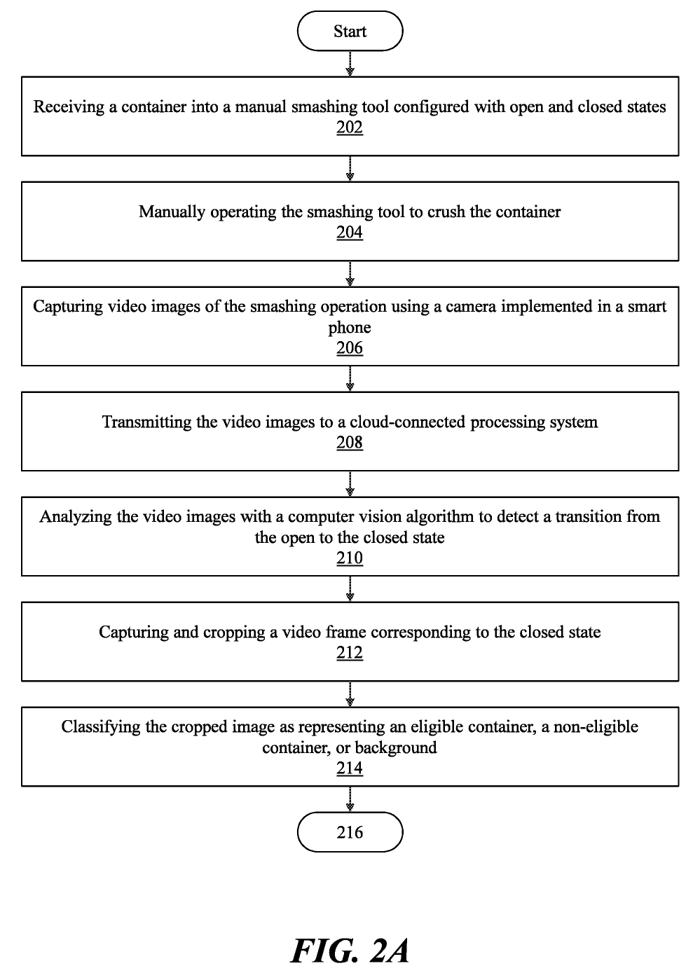

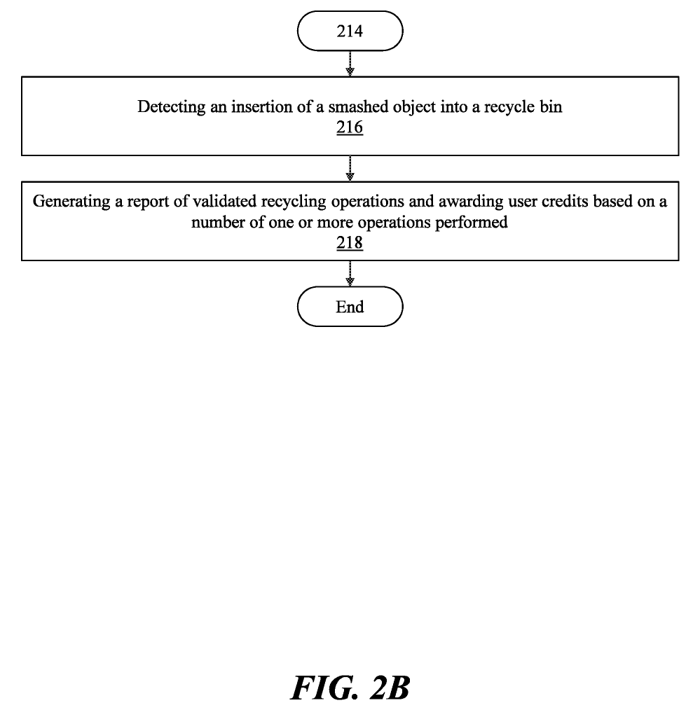

FIGS. 2A and 2B show flowcharts outlining a method for recycling one or more containers of any recyclable material, such as metal, plastic, and/or glass, according to some embodiments of the present disclosure. At block 202, the method includes receiving a bottle and/or a can into a manual smashing tool that is configured with open and closed states. Block 204 involves manually operating the smashing tool to crush the bottle and/or the can, followed by block 206, where video images of the smashing operation are captured using one or more sensors such as a camera. In block 208, the video images are transmitted to a cloud-connected processing system for further analysis.

At block 210, the method involves analyzing the video images with a computer vision algorithm to detect the transition from the open to the closed state of the smashing tool. Block 212 includes capturing and cropping a video frame corresponding to the closed state, and block 214 involves classifying the cropped image as an eligible bottle, eligible can, non-eligible bottle, or background. In block 216, the method detects the insertion of the smashed object into the recycle bin. Finally, at block 218, the method generates a report of validated recycling operations and awards user credits based on the number of operations performed. The blocks 202 through block 218 may be executed as part of the method, and in some embodiments, the method may also include displaying the generated report on a user interface.

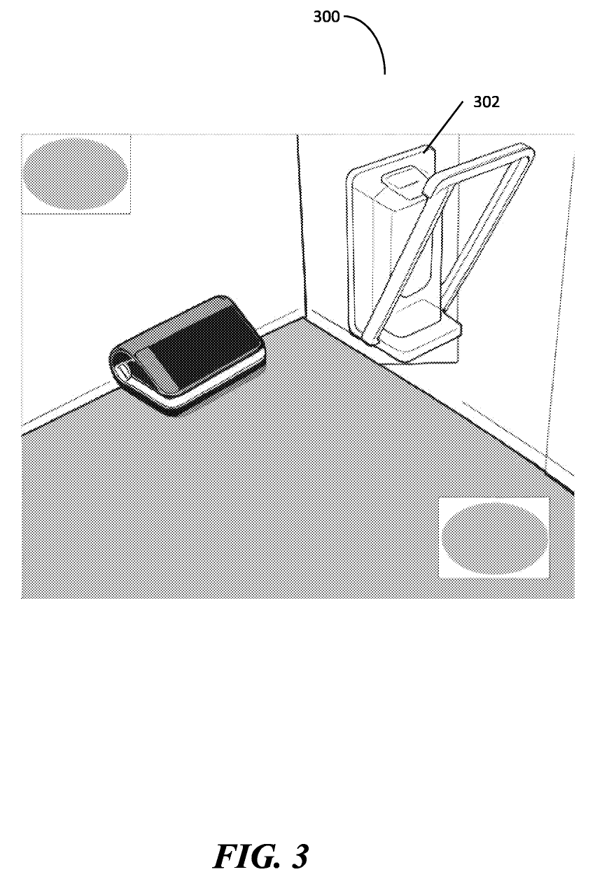

FIG. 3 illustrates an example recycling system 300 for one or more containers. The system includes a manual smashing tool 302 configured to receive and crush a bottle or can, with the tool having clearly defined open and closed states. Additionally, the system features a recycle bin with an insertion aperture configured to receive the smashed material. A sensor, such as a camera, is also included to capture video images of the smashing operation.

As noted above, the hardware components of the recycling system include a manual smashing tool, a recycle bin, and a camera. The manual smashing tool is configured with a lever or press mechanism that transitions between two distinct states: an open (ready) state and a closed (activated) state. In the open state, the user can insert a bottle or can, while the closed state initiates the crushing action when manually activated by the user. The physical design of the tool incorporates a handle that provides mechanical advantage for crushing materials. Optional mechanical sensors, such as proximity switches or pressure-sensitive elements, may be integrated into the tool to detect its transition between open and closed states, enhancing operational precision. These sensors communicate the operational state of the tool to the system's cloud-connected processing unit, ensuring accurate tracking of the crushing process.

The recycle bin is equipped with an insertion aperture configured to accept materials that have been processed by the smashing tool. The shape and size of the aperture are engineered to ensure that crushed one or more containers are inserted, preventing the deposit of non-recycled items, like unprocessed containers. This feature ensures that properly crushed materials are directed into the bin, improving recycling accuracy and efficiency. The aperture's design may be contoured or tapered to accommodate the size and shape of crushed one or more containers while excluding other materials.

In some embodiments, the recycling system is further configured to prevent the insertion of non-eligible products at a subsequent stage of the recycling process. In this context, a "non-eligible product" may include any object that does not satisfy predefined validation criteria for participation in the recycling program, including non-recyclable materials, improperly processed containers, foreign objects, contaminated containers, oversized items, or items placed at an incorrect processing panel. In certain embodiments, prevention may occur through mechanical, optical, electronic, or algorithmic control mechanisms, individually or in combination. For example, the recycle bin may include a selectively actuated gate, flap, sliding barrier, locking aperture, or controllable shutter mechanism positioned adjacent to the insertion aperture. The cloud-connected processing system, upon determining that a detected object does not qualify as an eligible container based on classification results, may transmit a control signal to maintain the gate in a closed or restricted configuration, thereby physically preventing insertion.

In some embodiments, the system may incorporate dynamic aperture control, wherein the insertion aperture is configured to change between an enabled state and a disabled state based on validation results. In an enabled state, the aperture allows passage of a properly validated crushed container. In a disabled state, the aperture is partially or fully obstructed to block insertion of a non- eligible product. In certain embodiments, the prevention mechanism may rely on real-time correlation between (i) a detected crushing event and (ii) a verified classification result. If a container fails classification, if no eligible crushing event is detected within a predetermined time window, or if the object does not match the expected geometry associated with the selected panel, the system may deny authorization for insertion. The system may require successful validation of the smashing operation prior to enabling the aperture for deposit.

In some embodiments, the system may further employ insertion monitoring at the aperture using one or more sensors, including, but not limited to, a camera, computer vision, depth sensing, infrared sensing, proximity sensors, weight sensors, or combinations thereof. If an object approaching the aperture does not correspond to a previously validated crushing event, the system may trigger a rejection response, which may include closing the aperture, generating a visual or audible alert, denying credit allocation, logging the event for audit purposes, or notifying an administrator through a management dashboard. In certain embodiments, prevention may also occur through delayed validation logic. For example, even if a container passes through the aperture, the system may retroactively invalidate the recycling event if subsequent analysis determines that the object was non- eligible. In such embodiments, the system may withhold or revoke credits, flag the user account, or require administrative review.

In some embodiments, the prevention mechanism enhances system integrity by ensuring that only properly validated containers are accepted into the recycling stream. This reduces contamination, prevents fraudulent credit accumulation, and maintains alignment between mechanical preprocessing requirements and incentive allocation logic. By integrating classification verification with controlled insertion authorization, the system establishes a closed-loop validation framework in which physical disposal is contingent upon algorithmic approval. This architecture improves operational reliability, reduces downstream sorting costs, and strengthens the accuracy of recycling participation tracking within the incentive system.

In some embodiments, a high-resolution camera may be implemented within a mobile device, such as a smartphone or tablet, rather than as a fixed, mounted unit. In this configuration, the process may be initiated when the user places the mobile device in a designated position relative to the compression apparatus and recycle bin. Placement of the device at the designated location may trigger activation of the device's flashlight while simultaneously causing the camera to focus on a predefined capture zone corresponding to the container processing area. The illuminated capture zone improves visibility of the deformation and insertion space while enabling consistent image acquisition. The mobile device camera may then capture video data of the compression operation and material insertion process. The field of view may include both the compression apparatus and the recycle bin entry point to allow coordinated monitoring of deformation and disposal actions. The captured video may be transmitted to a cloud-connected processing unit for analysis of tool state transitions and container classification. This mobile-device-based configuration enables flexible deployment without requiring permanently installed imaging hardware. The camera may be implemented within a mobile device, such as a smartphone or tablet, and may be calibrated to detect one or more transitions, such as when the smashing tool moves from an open to a closed state, and it helps identify and classify the materials being crushed. The camera may be implemented within a mobile device, such as a smartphone or tablet, and may include features such as adjustable zoom, autofocus, or dynamic exposure to facilitate performance under various lighting conditions, enabling reliable image data for the computer vision algorithms.

The software and processing components of the recycling system consist of several key elements, including a computer vision algorithm, insertion verification, and a reporting processor integrated with a user credit system. The computer vision algorithm runs on a cloud-based server and plays a critical role in monitoring, analyzing, and classifying the recycling operations. The algorithm begins by detecting state transitions of the manual smasher from its open to closed configuration, signaling the commencement of a smashing operation. This state detection ensures that the system can track the initiation of each crushing action with high accuracy.

Once the closed state is detected, the system retrieves the corresponding video frame or a sequence of frames captured by the camera during the smashing operation. The algorithm then performs image cropping to focus on the region of interest where the obj ect is held within the smashing tool, isolating the relevant area for further analysis. The cropped image is processed using machine learning classifiers to determine the type of object being crushed. The system classifies the object into one of the following categories: an eligible bottle of any recyclable material, such as metal, plastic, and/or glass, an eligible can of any recyclable material, such as metal, plastic, and/or glass, a non- eligible bottle (such as improperly inserted items), or background (indicating the absence of an object). This classification ensures that only properly crushed, eligible items are counted towards the recycling process.

Following the crushing operation, the system also verifies that the user has correctly inserted the smashed object into the recycle bin. This additional verification step ensures that only items that have both been smashed and disposed of properly are counted as eligible recycling actions. The system then aggregates these validated recycling operations over a predetermined time period or session, generating a detailed report listing the number and types of eligible recycling actions. Based on these verified actions, the system calculates credits and assigns them to the user. The credits may be displayed on a user interface or transmitted to a central rewards system for further tracking and incentives.

The operational flow of the recycling system is as follows: Step 1 involves the user inserting a bottle or can of any recyclable material, such as metal, plastic, and/or glass, into the manual smasher and activating the tool, which transitions from the open to closed state, crushing the material. Step 2 consists of the camera capturing video footage during this operation. The cloud-connected processing system detects the state change, crops the relevant image area, and classifies the crushed object accordingly. In Step 3, the user inserts the smashed object into the aperture of the recycle bin. Step 4 verifies the operation by confirming that both the smashing and the proper disposal of the item are completed. The system logs this action as eligible, maintains a running report, and awards credits to the user based on the validated recycling actions.

As noted above, the system utilizes computer vision to continuously monitor both the smasher activity zone and the recycle bin activity zone, with a particular focus on the aperture of the recycle bin. In the smasher activity zone, the system tracks the manual smashing tool as it transitions from the open to the closed state. This transition triggers the system to begin analyzing the crushing process. The computer vision algorithm detects the object being placed into the smasher, ensuring that the proper material (such as a bottle and/or can of any recyclable material, such as metal, plastic, and/or glass) is positioned correctly for crushing.

Concurrently, the system also monitors the recycle bin's activity zone, such as the aperture through which the smashed object is inserted. This ensures that the object, once crushed, is correctly deposited into the recycle bin. The aperture is configured to accept only the smashed material, preventing non-recyclable or improperly processed items from being deposited. Using video capture, the computer vision system verifies that the smashed object is placed through the correct aperture, confirming that the disposal process aligns with the recycling protocol. By monitoring both zones, during the crushing action at the smasher and the insertion process at the recycle bin aperture, the system can ensure that each step in the recycling process is properly executed, enhancing the accuracy of the recycling operation. This comprehensive tracking helps maintain the integrity of the recycling process, ensuring only eligible materials are processed and disposed of correctly.

In some embodiments, the system is configured to identify a container according to a combination of multiple observable and derived parameters, including geometric shape characteristics, material properties, and wording or other surface indicia present on the container. The computer vision algorithm evaluates these parameters collectively rather than independently, thereby increasing classification reliability and reducing the likelihood of false validation events. With respect to shape, the system may analyze the external contour of the object, including cylindrical sidewalls, conical tapering, neck formation, rim geometry, base curvature, and symmetry characteristics. The algorithm may evaluate dimensional ratios such as height-to-diameter ratio, top-to-body proportional relationships, curvature continuity, and edge transitions. In some embodiments, the system may distinguish a beverage can from a bottle based on the absence of a neck region, the presence of a rolled rim, or the detection of a pull-tab opening profile. In some embodiments, the system may evaluate post-crush deformation signatures, such as axial compression folds typical of aluminum cans, spiral buckling patterns of thin-walled metal, or lateral crumpling patterns characteristic of polyethylene terephthalate bottles.

The system may further detect irregular geometries inconsistent with standard container formats, such as polygonal edges, flat planar panels inconsistent with cylindrical bodies, or discontinuous contour lines indicative of foreign objects. In some embodiments, the system may utilize edge detection, contour mapping, feature vector extraction, bounding box analysis, and depth estimation techniques to evaluate shape characteristics. In certain embodiments, stereoscopic imaging, depth cameras, structured light, or monocular depth inference models may be used to estimate three- dimensional structure, enabling differentiation between hollow containers and solid objects.

With respect to material properties, the system may evaluate optical characteristics such as reflectivity, gloss level, specular highlights, diffuse reflection, transparency, translucency, opacity gradients, and surface texture granularity. Metallic cans may be identified through high specular reflectivity, uniform metallic sheen, and characteristic highlight patterns under directional lighting. Plastic containers may be identified by semi-transparency, light scattering along sidewalls, visible liquid residue silhouettes, label shrink-wrap distortion patterns, or elasticity-related deformation characteristics. Glass containers may be identified by refractive edge distortions, internal reflection artifacts, and higher rigidity deformation behavior during crushing. In some embodiments, color distribution analysis may assist in identifying aluminum cans with printed branding versus clear or green-tinted glass bottles. In certain embodiments, the system may evaluate thermal response signatures, polarization characteristics, or infrared reflectance differences to distinguish between metallic, polymeric, and glass materials. In other embodiments, the system may infer material type based on crush behavior, such as rebound elasticity of plastic, brittle fracture indicators of glass, or fold retention patterns of aluminum.

With respect to wording and surface indicia, the system may analyze printed text, logos, symbols, barcodes, recycling codes, deposit markings, product branding, and regulatory information printed on the container surface. Optical character recognition techniques may be applied to identify alphanumeric sequences, brand names, volume indicators, recycling resin identification numbers, or deposit refund statements. In some embodiments, the system may detect universal recycling symbols, resin identification triangles with numeric codes, or standardized beverage labeling layouts. In certain embodiments, partial text fragments may be sufficient for probabilistic matching against a stored database of known container templates. For example, detection of beverage-related wording, such as nutritional panel formatting or ingredient list structures, may increase classification confidence. In some embodiments, the system may also analyze graphical elements such as color bands, label orientation, barcode placement zones, manufacturer logos, or standardized container artwork arrangements. The system may maintain a reference dataset of common beverage container patterns and compare extracted visual features against known models to enhance classification confidence. In certain embodiments, the system may evaluate whether detected wording is distorted or fragmented in a manner consistent with post-crush deformation, thereby confirming that the object was previously a labeled beverage container.

The system may compute individual confidence scores for shape conformity, material likelihood, and wording recognition. These scores may be combined using weighted averaging, probabilistic fusion, neural network embedding layers, ensemble learning methods, or rule-based decision logic. In some embodiments, an eligible classification may require that at least two of the three parameter categories exceed predefined confidence thresholds. In other embodiments, the weighting may be dynamically adjusted based on environmental conditions, lighting variability, or panel designation. For example, if glare or lighting reduces material reflectivity reliability, the system may assign greater weighting to geometric shape and textual recognition. If crushing significantly distorts shape clarity, the system may rely more heavily on detected wording fragments and material reflectance characteristics. If labels are removed or obscured, the system may prioritize deformation patterns and structural geometry.

In some embodiments, the system may further evaluate contextual parameters such as temporal correlation with a detected smashing event, expected panel category, object motion trajectory, and insertion timing relative to classification. An object that matches expected shape and material parameters but lacks textual indicators may still be validated if it appears in the correct panel and follows a verified crushing cycle. Conversely, an object exhibiting misleading text but lacking appropriate geometric conformity may be classified as non-eligible. By integrating multiple identification parameters, including shape, material, and wording, the system improves discrimination between eligible containers and non-eligible products. This multi-factor identification framework increases robustness against label removal, surface contamination, lighting variability, deformation artifacts, and attempts to introduce foreign objects. The combined parameter approach enhances the accuracy of validation decisions, strengthens the integrity of the incentive allocation process, and reduces contamination risk within the recycling stream.

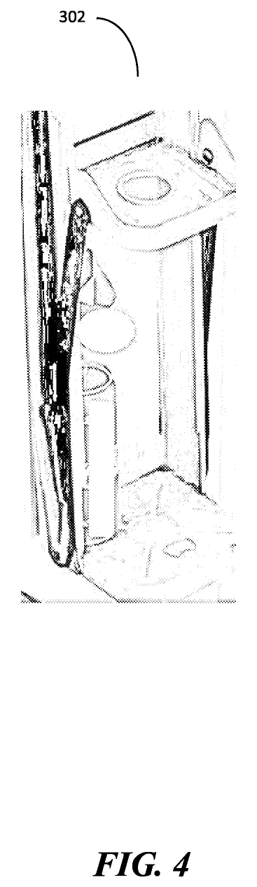

FIG. 4 is a block diagram providing further details of the manual smashing tool 302 of the recycling system 300, as shown in FIG. 3. The manual smashing tool 302 is mechanically configured to receive and crush plastic, metal, and/or glass bottles and/or cans, with a defined operational range between an open and a closed position. The tool is equipped with a lever or handle mechanism that enables manual compression of the bottle or can, which activates the crushing process. In an embodiment, integrated mechanical position sensors and/or switches may be embedded within the tool, allowing for the detection of transitions between the open and closed states. These sensors interface with the cloud-connected processing system 140 to relay state information in real time. This data assists in tracking the operational cycle of the tool and ensuring accurate classification of the materials being crushed. The tool is configured to ensure that appropriately smashed materials are passed to the recycle bin, which features an insertion aperture tailored to accept the crushed objects.

In one example implementation, the recycling system is configured to perform frame cropping and object classification in order to accurately identify and classify the object being crushed. Initially, the system captures a video feed of the manual smashing operation, including both the manual smasher and the object being crushed. Once the manual smasher transitions from the open to the closed state, indicating that the smashing action has begun, the video feed is analyzed by the computer vision algorithm. The algorithm identifies the area of interest within the frame where the object is being held in the smasher. To isolate this area, the system crops the video frame around the object, focusing specifically on the region where the bottle or can is positioned. This cropping process ensures that the algorithm analyzes only the relevant portion of the image, removing unnecessary background or surrounding elements that may interfere with the classification.

Following the cropping process, the system employs a machine learning-based classification model to identify the object. In this specific case, the system classifies the object as a "can of drink." The classification process involves analyzing the cropped image using a trained machine learning classifier, which has been previously trained to recognize various types of recyclable items, such as plastic bottles, aluminum cans, or non-recyclable objects. In this scenario, the system correctly identifies the object as an eligible "can of drink" based on its visual features, such as shape, material, and label. Once classified, the system logs the object type as an eligible recycling item and proceeds with the subsequent steps of verification and reporting, ensuring that the operation is accurately recorded and credited to the user. The classification result also allows the system to filter and track different types of recyclable materials, further improving the efficiency and accuracy of the recycling process.

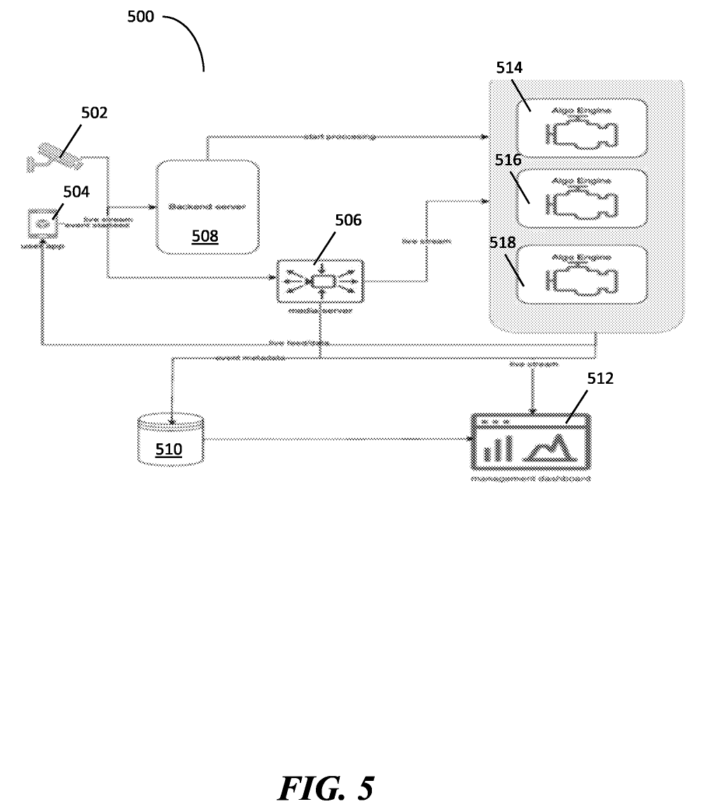

FIG. 5 is a block diagram further illustrating the system architecture 500 of the recycling system from FIG. 1. The user will initiate a recycling event using the mobile application, which serves as the interface for starting and managing the process. Once the user triggers the event, a request is sent to a background server, which in turn communicates with one or more algorithm engines to begin processing. The algorithm engine is responsible for handling the live stream data, which is received directly from the media server that captures the user's actions.

As the user manually crushes one or more containers of any material (such as plastic bottles, aluminum cans, glass bottles, or other recyclable containers) using the manual smashing machine, the system continuously monitors the event through the camera. The camera captures the live stream of the user's actions, including the smashing operation and the subsequent insertion of the crushed containers into a designated aperture in a container, such as a recycling bin. The algorithm engine processes this live stream to detect and classify the objects being smashed, while tracking the user's progress. The processing continues in real-time until the user marks the event as finished in the mobile app. At this point, the algorithm engine halts its processing. During the event, the system continuously analyzes the live video stream to count the eligible containers and crushed objects. These counts, along with the classification of each container (eligible, recyclable container, such as a plastic bottle, eligible can, glass bottle, etc.), are sent to the user's app. This information may be transmitted directly to the app or via a backend server, ensuring that the data is updated in real-time for the user.

Concurrently, the live stream and/or updated screenshots of the event are sent to the management dashboard. This allows system administrators or other authorized personnel to monitor the event remotely. In addition to the live video feed, all event-related data and metadata, such as the number of containers processed, classification results, timestamps, and user actions, are transmitted to the dashboard, providing detailed insights into the recycling process. This setup ensures both real- time monitoring and detailed reporting of recycling actions, enabling efficient system management and immediate feedback to users, regardless of the material of the containers being processed.

The mobile application facilitates the user's engagement with the recycling system by tracking and rewarding eligible recycling actions. Upon initiating a recycling event, the user begins by selecting a container (e.g., plastic bottle, aluminum can, or other recyclable material) and manually activates the crushing mechanism and interacts with the app. This action triggers the backend server to request processing from the algorithm engine, which begins analyzing the live video stream captured by the camera. The live stream monitors the user's interaction with the manual smasher and the recycling bin, tracking the manual crushing of containers and their insertion into the designated aperture of the bin. The system utilizes computer vision algorithms to validate each container, verifying that it has been properly crushed and inserted into the bin.

In some embodiments, the manual smashing tool is fully mechanical in construction and operation and does not require electricity, battery power, wired power connections, or electronic actuation in order to perform the crushing function. The tool may operate solely through user-applied mechanical force, such as lever actuation, compression, rotation, or cam-based engagement. In certain embodiments, the crushing mechanism may include a lever arm, pivot joint, linkage assembly, compression plate, guide rails, or mechanical stop features configured to provide mechanical advantage without electrical assistance. The absence of electrical components within the crushing mechanism allows the device to operate reliably in outdoor environments, remote locations, and areas lacking stable power infrastructure.

In some embodiments, the mechanical configuration may include spring-biased return mechanisms, gravity-assisted reset features, ratcheting components, or counterweight systems that restore the tool from a closed state to an open state after actuation. These components may be purely mechanical and may operate independently of electronic control systems. The crushing plates or compression surfaces may be fabricated from hardened steel, aluminum alloy, composite material, or other durable materials capable of withstanding repeated mechanical loads. In certain embodiments, the tool may be mounted to a wall, frame, or standalone support structure to ensure stability during manual operation.

In certain embodiments, the mechanical smashing tool may nevertheless interface with optional passive sensors that do not require direct electrical actuation of the crushing function. For example, non-powered mechanical switches, reed switches, magnetic indicators, or position flags may be integrated into the structure to indicate open or closed states. In some implementations, these sensors may transmit signals to the processing system, but the crushing action itself remains entirely manual and mechanically driven. The core material deformation process therefore does not depend on any powered component.

In some embodiments, the mechanical-only design supports scalability in regions with limited infrastructure by enabling low-cost deployment without electrical installation requirements. The crushing tool may be transported and installed without specialized electrical setup. This configuration allows the recycling verification system to be deployed in rural areas, temporary event spaces, disaster recovery zones, or mobile recycling campaigns. By separating the mechanical crushing function from the electronic verification components, the system maintains functional simplicity while allowing optional integration with advanced computer vision and reporting technologies when available.

Once the user marks the event as finished in the app, the algorithm engine stops processing and calculates the total number of eligible recycling operations. The algorithm performs an object classification to determine the number of containers that qualify as eligible recyclables, ensuring that only properly crushed and disposed containers are counted. The app then calculates the corresponding reward credits based on the validated actions, which may vary depending on the type and quantity of materials recycled. The user is immediately notified of the reward, with credits displayed within the app interface. These credits accumulate over time and are available for redemption, depending on the reward system in place. The app may also track the user's progress on a leaderboard, allowing users to compare their recycling efforts with others, while offering additional incentives such as badges or social media sharing for further engagement. This process ensures real-time feedback, encourages recycling, and incentivizes sustainable behaviors through a continuous reward system.

In some embodiments, the credit allocation framework may be defined using configurable numerical ranges, thresholds, and multipliers that are adjustable based on program objectives, material value, geographic region, regulatory environment, or sponsorship arrangements. In certain implementations, users located in Israel may receive credits denominated in New Israeli Shekels (NIS) as part of the incentive structure. The denomination of credits may therefore be adapted to reflect local currency or regional program requirements. This localized credit model allows the system to align incentives with applicable market conditions and consumer programs. The reporting processor may include a configurable rules engine that stores these parameters in memory and applies them dynamically during validation of recycling events. This architecture enables program administrators to modify incentive structures without requiring changes to the core mechanical or computer vision components of the system. For example, base credit values, bonus multipliers, and redemption thresholds may be remotely updated through the cloud-connected processing system. In certain embodiments, these parameters may be periodically recalibrated in response to material market pricing, recycling demand fluctuations, or participation metrics. By implementing configurable ranges, the system maintains flexibility while preserving consistency and auditability of reward calculations.

In some embodiments, a base refund or credit value may be assigned per validated container based on container size. For example, smaller containers may be assigned a value within a first range, while medium-sized containers may be assigned a value within a second range, and larger containers may be assigned a value within a third range. The specific value assigned may further depend on local deposit policies, regulatory frameworks, or program requirements applicable to the container size category. For instance, containers up to a first volume threshold may receive a lower refund value, containers within a mid-volume range may receive a higher refund value, and containers exceeding a larger volume threshold may receive the highest refund value. These size-based ranges provide a structured foundation upon which additional multipliers or incentive mechanisms may operate where applicable. In certain embodiments, bonus multipliers may be applied when the quantity of validated containers within a defined session falls within predetermined quantity bands. For example, when a user processes between about 1 and about 10 validated containers in a single session, a first multiplier in a range of about 1.Ox to about 1.2x may apply. When the quantity increases to between about 11 and about 50 containers, a second multiplier in a range of about 1.1x to about 1.5x may be applied. For higher volume sessions exceeding about 50 containers, a third multiplier in a range of about 1.2x to about 2.0x may apply. In some embodiments, multipliers may increase incrementally for each additional block of containers, such as per 10-container increment beyond a baseline threshold. This quantity-based incentive structure encourages higher participation while maintaining predictable scaling of rewards.

In some embodiments, cumulative recycling totals over extended time periods may trigger tier-based rewards that operate independently from single-session multipliers. For example, a first tier may be achieved upon validation of about 25 to about 100 containers within a 30-day period. A second tier may correspond to validation of about 100 to about 500 containers during the same timeframe. A third tier may correspond to validation exceeding about 500 to about 5,000 containers within a defined monthly or annual period. Each tier may provide additional bonus credits within a range of about 5 percent to about 100 percent of accumulated base credits. This tiered approach incentivizes sustained engagement rather than isolated recycling events.

In certain embodiments, station-based differentiation may be implemented to reflect the physical deployment context of a recycling station rather than campaign-driven incentives. The refund or credit value provided to users may vary depending on whether the station is located in a commercial environment, such as a supermarket, or within a residential setting, such as an apartment complex or neighborhood facility. For example, a station deployed at a retail location may provide a first refund structure aligned with store participation or logistical integration, while a station installed in a residential building may provide a different refund structure reflecting local usage patterns or collection efficiencies. This station-based segmentation operates independently of promotional campaigns and is instead determined by station type and operational context. Such differentiation enables the system to support varied deployment environments while maintaining consistent validation logic across locations. In some embodiments, time-based incentive windows may apply additional multipliers within a range of about 1.1x to about 2.Ox during predefined promotional periods or material recovery campaigns. These time-based incentives may be activated during environmental awareness events, recycling competitions, or seasonal material surpluses. In certain embodiments, dynamic adjustment mechanisms may temporarily increase aluminum can credits within a range of about 10 percent to about 200 percent during periods of elevated aluminum recovery demand. The system may automatically adjust these values based on external market data or administrator input. Time-based multipliers may be applied in conjunction with quantity-based and station-based multipliers, subject to predefined stacking rules. This layered incentive model allows for dynamic and responsive reward management.

In some embodiments, improper processing or validation failures may result in reduced or eliminated refund allocation, which is provided directly to users in New Israeli Shekels (NIS) without any need for conversion. Containers that fail insertion verification may receive no refund value. In certain embodiments, repeated validation failures may result in temporary reduction of future refund eligibility for a defined period. These reduction mechanisms are applied to discourage misuse while maintaining fairness in the allocation of refunds. The system may log such events for monitoring, audit, or reporting purposes. The system is configured to function even in the absence of internet connectivity or power to the camera by utilizing a mobile app. In this configuration, the user is still able to capture the video footage of the manual smashing operation using their own device, such as a smartphone or tablet. The app is configured to interface with the system, allowing the user to manually record the smashing operation locally, even when the camera is not powered or connected to the cloud.

Once the smashing operation is completed, the user can upload the recorded video to the cloud- based processing system via the app when an internet connection becomes available. This facilitates verification of the recycling actions without requiring real-time video streaming. The app's functionality allows for data transmission to the cloud-based system at a later time, enabling the computer vision algorithm to process and classify the captured footage. The user's actions are still tracked and verified, and the proper credits are awarded once the video is uploaded and processed, maintaining the system's integrity even in low connectivity situations. This capability ensures that the system can operate effectively in locations where real-time internet access may not be available, allowing for continued participation in the recycling process without disruptions. It also provides a flexible user experience, enabling users to engage with the system at their convenience and upload their data when they have access to a network.

In some embodiments, the mobile application and associated backend infrastructure provide, for the first time, a structured and verifiable dataset regarding consumer behavior related to soft drinks, canned beverages, bottled beverages, and other products sold in containers. Unlike conventional recycling programs that rely solely on aggregate material weights or anonymous deposit returns, the present system links validated recycling events to identifiable user accounts, enabling granular behavioral analytics. The system may collect user identity information, which may include a registered account identifier, username, or anonymized unique token. In certain embodiments, location data associated with the recycling event may be captured, including GPS coordinates from the mobile device, station identifier, or facility location metadata. In addition, the system may infer consumption volume based on the number and type of validated containers deposited, thereby providing data indicative of how much a particular user or group consumed over a defined time period.

In some embodiments, the algorithm aggregates and stores container-related data in a centralized database controlled by the system operator. This database may include structured fields corresponding to container type, timestamp of crushing, timestamp of insertion, station identifier, classification result, confidence score, and associated user account. In certain embodiments, the system also stores image frames or video segments corresponding to validated recycling events. These video records may be used for audit verification, fraud prevention, model retraining, and data quality control. The database may include metadata such as container category, material type, deformation profile, and detected textual features.

In some embodiments, consumption analytics may be derived by correlating container count and container type with standardized container volume values. For example, a validated aluminum beverage can may correspond to a predefined liquid volume, such as approximately 250 milliliters, 330 milliliters, 355 milliliters, or 500 milliliters. A validated plastic bottle may correspond to predefined volume classes, such as approximately 500 milliliters, 1 liter, 1.5 liters, or 2 liters. By summing validated container counts and associated volume categories, the system may estimate total beverage consumption for a given user over daily, weekly, monthly, or annual intervals. In certain embodiments, these consumption estimates may be aggregated across geographic regions, demographic groups, or promotional campaigns.

In some embodiments, the stored video and image data may be used to enhance future classification capabilities, including brand-level recognition. The system may train or retrain machine learning models using accumulated labeled image data to detect brand-specific visual patterns. These patterns may include logo placement, color schemes, typography, barcode region formatting, label layout, graphic elements, and characteristic packaging design features. In certain embodiments, the algorithm may extract and encode feature embeddings representing brand identifiers. Over time, the system may improve its ability to distinguish between different manufacturers, product lines, or beverage categories.

In some embodiments, brand identification may enable advanced analytics beyond material classification. For example, the system may generate reports indicating the frequency of specific brands recycled within a geographic region. In certain embodiments, the system may identify shifts in consumer preference by detecting increased recycling frequency of particular container designs. In some implementations, brand-level recognition may enable partnership programs with manufacturers, targeted promotional campaigns, or brand-sponsored recycling incentives.

In certain embodiments, the database may be configured to store container-related video data for a defined retention period within a range of about 24 hours to about several weeks, depending on regulatory requirements and data governance policies. The system may implement encryption, access controls, anonymization protocols, and audit logging mechanisms to protect stored identity and location data. In some embodiments, user identity may be stored in pseudonymized form while still enabling consumption trend analysis. In other embodiments, users may opt-in to enhanced data sharing features in exchange for additional incentives.

In some embodiments, the system may generate predictive models based on historical consumption and recycling behavior. These models may identify consumption frequency patterns, seasonal trends, brand loyalty indicators, or station utilization patterns. In certain embodiments, predictive analytics may support supply chain optimization, inventory forecasting, or municipal recycling planning. By linking validated recycling events to user identity, location, and container classification data, the system creates a novel behavioral dataset not available in traditional recycling infrastructures.

In some embodiments, the integration of verified physical recycling events with digital identity and cloud-based analytics provides a technical advantage by ensuring that recorded consumption data corresponds to actual physical container disposal. This verification reduces reliance on survey-based or purchase-based estimates and instead anchors behavioral analytics to validated container processing events. Over time, the system may build a comprehensive dataset correlating consumption volume, brand preference, geographic location, and recycling compliance behavior. This capability supports both operational optimization and strategic insights into consumer packaged goods usage patterns.

FIG. 5 illustrates a system architecture 500 configured to support real-time validation of recycling events, container classification, behavioral analytics, and administrative monitoring. In the illustrated embodiment, reference numeral 502 corresponds to a camera configured to capture video of the recycling process. The camera 502 may be mounted adjacent to the manual smashing tool, integrated into a recycling station housing, ceiling-mounted above the activity zone, or positioned on a support structure providing a clear field of view of both the crushing area and the insertion aperture. In some embodiments, the camera 502 may be a high-resolution digital camera, IP camera, wide-angle camera, depth-sensing camera, infrared camera, or multi-lens imaging device, and/or may be implemented in any device, such as a mobile device, a smart phone, and/or a tablet. The camera 502 may continuously capture video during a recycling session or may be activated upon event initiation. The captured video feed may include both the smashing operation and the subsequent insertion of the crushed container into the recycle bin.

In some embodiments, the user interacts with a user application 504 that communicates with the backend server 508 to initiate and manage a recycling session. The user application 504 may run on a smartphone, tablet, kiosk interface, or other computing device and may allow a user to authenticate, start a recycling event, select a station or container category, and end the event. Upon initiation of the recycling event through the user application 504, a start-processing signal is transmitted to the backend server 508. The backend server 508 may generate a unique session identifier and associate it with the camera 502 and station location. In certain embodiments, the backend server 508 may also transmit configuration parameters to downstream processing components, such as expected container type, credit multiplier rules, or campaign-specific incentive structures. This coordination ensures that video captured by camera 502 is associated with the correct user session and validation rules.

In certain embodiments, the media server 506 is configured to ingest live video stream data from a camera implemented within a mobile device. Initially, the camera may be configured to focus on a defined square capture area where the container is intended to be placed. The media server 506 may perform functions such as buffering, encoding, frame extraction, compression, bitrate optimization, and stream routing. In some embodiments, the media server 506 may segment the incoming video feed into discrete time windows corresponding to the container placement, deformation event, and insertion event. The media server 506 may also isolate regions of interest within the video stream, such as the manual smashing zone and the recycle bin aperture zone, before forwarding relevant data to algorithm engines. In distributed implementations, multiple media servers may be deployed across geographic regions to reduce latency and improve scalability. The media server 506 thus serves as an intermediary layer between the camera 502 and the computational analysis engines.

In certain embodiments, the system includes multiple algorithm engines 514, 516, and 518 configured to perform specialized processing tasks on the incoming video stream. One algorithm engine may detect mechanical state transitions of the manual smashing tool, such as transitions from an open configuration to a closed configuration. Another algorithm engine may perform region-of- interest cropping to isolate the container being crushed. A further engine may execute container classification functions, including shape analysis, material inference, textual recognition, and brand detection. In some embodiments, an additional engine may verify insertion of the crushed container into the recycle bin aperture and correlate this insertion event with the previously detected smashing event. The system may dynamically allocate processing loads across engines based on computational demand, traffic volume, or hardware availability, thereby supporting real-time performance.

In some embodiments, the outputs of the algorithm engines 514-518 are transmitted to the backend server 508 and/or stored in a data storage system 510. The data storage system 510 may include relational databases, distributed cloud storage systems, object storage repositories, or hybrid storage architectures. Stored data may include container classification category, detected brand (if identified), timestamp of smashing, timestamp of insertion, session identifier, user identifier, station identifier, and geolocation data. In certain embodiments, the system may store image frames or short video segments corresponding to validated recycling events for audit verification, fraud prevention, and machine learning retraining. Metadata may also include classification confidence scores, deformation metrics, text recognition results, and algorithm version identifiers. The structured storage of this information enables both operational validation and long-term behavioral analytics.

In certain embodiments, the management dashboard 512 provides administrators with real- time and historical visibility into system activity. The dashboard 512 may display live video streams from camera 502, container counts by type, brand distribution metrics, credit allocation summaries, and station utilization statistics. In some embodiments, the dashboard may provide geographic mapping of recycling activity, user participation trends, time-of-day usage patterns, and material recovery breakdowns. Administrators may use the dashboard to monitor system status, adjust credit multipliers, launch promotional campaigns, or investigate anomalous behavior. The dashboard may also provide exportable reports for municipalities, sponsors, manufacturers, or sustainability partners. By integrating visualization with backend data and algorithmic outputs, the management dashboard 512 enhances transparency and oversight.

In some embodiments, data and control signals flow bidirectionally among the camera 502, media server 506, algorithm engines 514-518, backend server 508, storage system 510, and management dashboard 512. When a user ends a recycling session through the user application 504, the backend server 508 may transmit a stop-processing command to the algorithm engines, thereby terminating live analysis. Final validated container counts, brand identifications, and credit calculations may then be transmitted to the user application 504. In certain embodiments, additional post-session processing may occur asynchronously to refine brand recognition or update predictive consumption models. The modular architecture allows the system to operate in real time while also supporting deferred analytics and model improvement.

In some embodiments, the architecture 500 is modular and extensible, enabling additional cameras, algorithm engines, or processing nodes to be integrated as deployment scales. For example, multiple cameras may be installed at a single station to provide multi-angle views, depth estimation, or occlusion reduction. Additional algorithm engines may be added to support advanced brand recognition, environmental impact estimation, anomaly detection, or predictive analytics. This modular design supports expansion from small pilot programs to large-scale municipal or corporate recycling networks. By combining camera-based imaging, distributed algorithmic processing, structured data storage, and administrative visualization, the architecture 500 provides a comprehensive technical framework for validated recycling analytics and consumer behavior tracking.

The recycling verification system provides concrete technological improvements over conventional recycling methods. The architecture integrates a camera-based imaging subsystem, a media ingestion layer, distributed algorithm engines, and structured data storage to validate physical recycling actions in real time. Unlike abstract incentive tracking mechanisms or manual reporting applications, the system operates on tangible physical inputs, including mechanical state transitions of a crushing tool and verified insertion events into a recycling receptacle. The system converts raw video data into structured, validated event records through event-triggered processing rather than continuous indiscriminate analysis. This event-driven architecture reduces unnecessary computational cycles and improves image processing efficiency. By anchoring digital credit allocation to verified physical interactions, the system improves technological reliability and data integrity within recycling infrastructures.

In some embodiments, the system improves computer vision performance by implementing region-of-interest cropping tied directly to mechanical tool state transitions while also protecting user privacy. When the compression apparatus transitions from an open configuration to a closed configuration, the processing engine isolates only those frames temporally associated with the mechanical actuation and the container processing zone. This targeted isolation reduces background noise, irrelevant motion artifacts, and non-container image data by focusing analysis on the containers rather than on surrounding individuals. As a result, the system processes container-related activity without requiring identification of the user. This approach enables accurate validation while maintaining privacy by ensuring that visual processing is limited to the recycling interaction itself. The approach decreases computational load by limiting classification operations to a defined spatial and temporal window. The resulting improvement in signal-to-noise ratio enhances object classification accuracy under variable lighting and environmental conditions. This technique constitutes an improvement to the functioning of video-processing computer systems by optimizing frame selection and reducing redundant processing.

The system further improves fraud prevention and validation integrity through a dual-stage verification architecture. Traditional recycling incentive systems rely on barcode scans, weight measurements, or self-reported entries, which cannot verify proper mechanical preprocessing of containers. The present system verifies both a crushing event and a corresponding insertion event using correlated video analysis. Credit allocation occurs only when both events are validated within a defined time window and spatial region. This closed-loop verification framework reduces susceptibility to manipulation and false reporting. By combining physical state detection with computer vision correlation logic, the system enhances technological reliability in validating recycling behavior.

The architecture improves distributed computing performance by modularizing imaging, media ingestion, session management, algorithmic processing, storage, and visualization components. Multiple algorithm engines may process live streams concurrently, enabling parallel computation and dynamic load balancing. The separation of functions allows independent scaling of computational resources based on user traffic or station density. Media ingestion and buffering optimize network throughput while reducing latency. Backend coordination ensures synchronized communication among processing engines and storage systems. This distributed configuration enhances the functioning of networked computing systems by improving scalability, resource allocation efficiency, and response time.

The structured storage subsystem improves database operation and downstream analytics by storing validated, correlated event metadata rather than unfiltered raw data. Each validated recycling event may include timestamps, station identifiers, classification results, confidence scores, and associated image segments. By storing structured and verified data, the system reduces redundancy and improves the integrity of behavioral analytics. Retention of selected image frames enables model retraining and algorithm refinement without requiring full stream storage. The database architecture supports efficient querying for consumption trends, station performance, and material distribution metrics. This structured storage methodology improves database efficiency and enhances the technical operation of analytics systems.

The multi-parameter classification framework enhances machine learning robustness by combining geometric shape analysis, material property inference, and textual recognition. Instead of relying on a single feature dimension, the system fuses multiple feature sets to improve discrimination accuracy. Shape-based features may include contour geometry and deformation profiles, while material features may include reflectivity and translucency characteristics. Textual recognition may identify brand logos, recycling codes, or packaging indicia. The fusion of these features increases classification confidence in scenarios involving deformation, partial occlusion, or lighting variability. This multi-factor approach improves the performance of computer vision algorithms operating in uncontrolled real-world environments.

The mechanical design of the crushing apparatus provides additional technical benefits by operating independently of electrical power. The crushing mechanism functions through manual force and mechanical advantage without requiring motors, wiring, or electronic actuation. This separation between mechanical deformation and digital validation increases system resilience during power interruptions. The imaging and processing subsystems may operate independently while the crushing tool remains mechanically functional. This hybrid architecture reduces infrastructure costs and improves deployment flexibility in remote or low-resource environments. By decoupling mechanical operation from electrical dependency, the system enhances reliability and uptime.

By integrating camera-triggered event detection, targeted image processing, distributed algorithm execution, structured metadata storage, and configurable validation logic, the system provides a technical solution to the problem of verifying physical recycling actions at scale. The system improves computer vision efficiency through event-based processing, enhances database integrity through structured validation, and strengthens distributed computing performance through modular architecture. Credit allocation is not based on abstract accounting rules but on verified, correlated physical events processed through specialized computational techniques. The improvements are rooted in specific hardware-software integration and image-processing optimizations. The combination of mechanical state detection and algorithmic correlation produces measurable enhancements in validation accuracy and system reliability. Accordingly, the system constitutes a practical application of computer technology that improves the functioning of computing systems and recycling verification infrastructure.

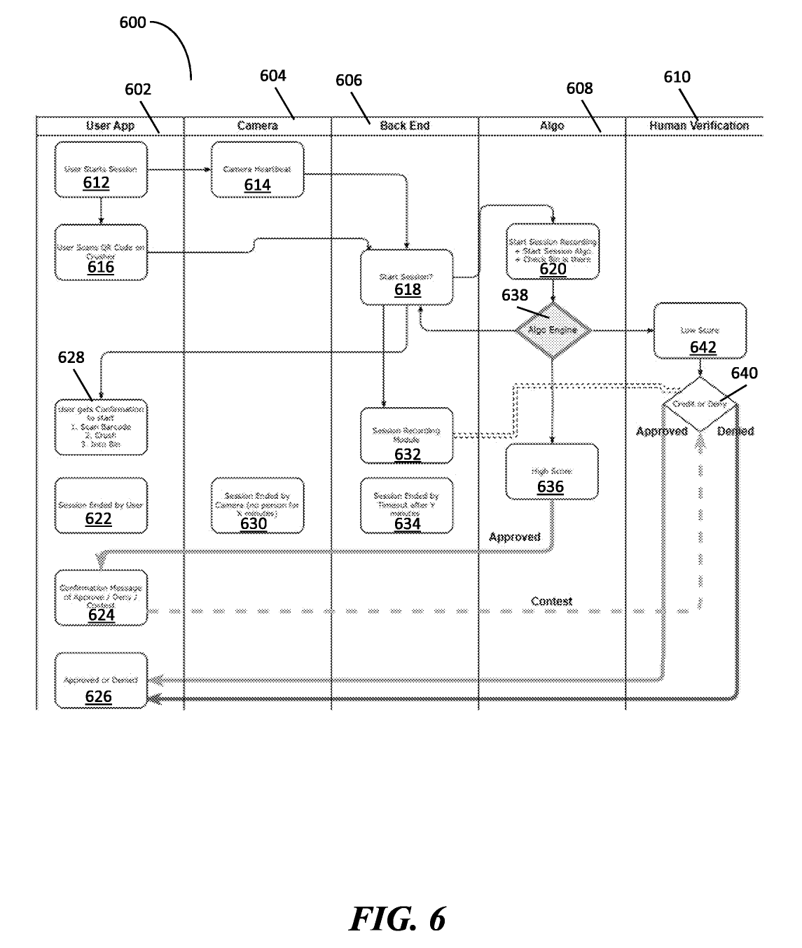

FIG. 6 illustrates a coordinated process architecture 600 that governs session initiation, live recording, algorithmic scoring, approval workflows, and optional human review. The architecture is divided into functional domains including a user application 602, a camera subsystem 604, a backend system 606, an algorithm engine 608, and a human verification module 610. These components operate in a synchronized manner to ensure validated recycling events are properly recorded and scored. The architecture supports both automated decision-making and optional escalation for manual review. The system enables session lifecycle management from initiation through approval, denial, or contest resolution. Each functional block may be implemented as software modules executed on one or more processors in a distributed computing environment.

In some embodiments, a user initiates a recycling session via the user application 602 by placing the phone at a designated position associated with the recycling station, which triggers a "User Starts Session" event 612. Placement of the phone may activate device features such as the camera and flashlight to prepare the capture zone for container processing. The positioning of the phone may associate the session with a specific station identifier, camera feed, and backend configuration profile without requiring a separate scanning step. Upon placement, the user may receive confirmation instructions 628 outlining required steps such as crushing and depositing into the bin. This structured initiation process ensures that sessions are tied to authenticated user accounts and verified station hardware. The application may also enforce session time limits and usage policies to prevent misuse.

In some embodiments, the application may prompt the user to scan a QR code located on a crusher or recycling station as indicated in step 616. The QR code scan may associate the session with a specific station identifier, camera feed, and backend configuration profile. Upon scanning, the user may receive confirmation instructions 628 outlining required steps such as scanning, crushing, and depositing into the bin. This structured initiation process ensures that sessions are tied to authenticated user accounts and verified station hardware. The application may also enforce session time limits and usage policies to prevent misuse.

The camera subsystem 604 includes a heartbeat monitoring process 614 to verify camera availability and operational readiness prior to session activation. If the camera is functioning properly, a start session request 618 is transmitted to the backend system 606. The camera subsystem may continuously stream video once recording begins. In some embodiments, the system may end a session automatically if no person is detected for a defined period, as illustrated in block 630. This inactivity timeout mechanism prevents idle or fraudulent sessions from remaining open. The camera subsystem thus plays a central role in ensuring eligible visual capture throughout the session lifecycle.

The backend system 606 manages session control, including start session request 618 for validation and operation of a session recording module 632. The backend coordinates video stream routing to the algorithm engine 608. The backend may also terminate sessions under defined conditions, such as timeout expiration illustrated in block 634. The session recording module 632 may segment video into discrete events corresponding to crushing and insertion actions. Metadata, including timestamps, user identifiers, and station identifiers, may be stored for each session. The backend therefore orchestrates communication between user application, camera, and algorithm components.

The algorithm engine 608 initiates scoring procedures upon receipt of the session start command, as shown in block 620. The algorithm may verify that a bin is present and that a crushing tool is detected prior to recording analysis. The engine processes the video stream and produces a classification confidence score. If the score exceeds a predefined high threshold, as shown in block 636, the recycling event may be automatically approved. If the score falls below a threshold, as indicated in block 642, the system may route the event to a review path. This score-based branching improves automated accuracy while preserving safeguards for ambiguous cases.

In cases of high confidence scoring 636, approval may be issued directly without further review. The backend may transmit an approval message 624 to the user application 602. The final decision state may be reflected as "Eligible for Refund" 626 within the user interface. In lower confidence scenarios 642, the system may forward the event to a human verification module 610. The human verification module may review video segments, classification metadata, and event timestamps. Based on review, the human verifier may issue a determination of "Eligible for Refund" or "Not Eligible for Refund" 640. If human verification results in "Non-Eligible," the system may provide the user with a contest pathway, as indicated in the dashed "Contest" flow. The contest mechanism allows review of disputed decisions through administrative intervention. Eligible container decisions may be transmitted back to the user application and reflected as final credit issuance. The layered architecture ensures that ambiguous algorithmic outputs do not automatically result in incorrect credit assignments. The combination of automated scoring and human escalation improves reliability and system integrity.

The architecture 600 thus establishes a complete session lifecycle management framework. It integrates user authentication, camera readiness validation, backend orchestration, algorithmic scoring thresholds, automated approval, conditional human review, and dispute resolution pathways. The flow improves validation accuracy while maintaining scalability through score-based automation. By combining real-time video processing with threshold-based branching and optional human oversight, the system enhances fraud prevention and operational reliability. This structured workflow ensures that recycling credits are awarded only after verified crushing and insertion actions have been properly validated.

In some embodiments, the recycling session may be terminated through a user-initiated action, as represented by block 622 ("Session Ended by User"). The user may manually indicate completion of the recycling activity through the user application interface, such as by selecting a "Finish Session," "End," or equivalent command. Upon receiving the termination input, the user application transmits a session end signal to the backend system. The backend system associates the termination signal with the active session identifier and triggers finalization procedures. The session end command may include metadata such as timestamp, user identifier, station identifier, and device identifier. This controlled termination process ensures that the session lifecycle is explicitly bounded by user interaction.

In some embodiments, the user-initiated session termination event 622 may trigger the backend system to halt video ingestion from the camera subsystem. The backend may send a stop- recording instruction to the media server and algorithm engine components. The session recording module may then close the active video segment and finalize associated metadata. Any buffered frames not yet processed by the algorithm engine may be flushed through the scoring pipeline prior to session closure. This ensures that all crushing and insertion actions performed during the session window are evaluated before credit determination. The termination event therefore acts as a synchronization point between recording, scoring, and data storage processes.

In certain embodiments, the algorithm engine may perform a final scoring pass upon session termination. For example, if multiple containers were processed during the session, the engine may aggregate individual classification results and calculate cumulative credit values. The system may verify that each container action includes both a crushing event and a correlated insertion event prior to session approval. If partial actions are detected, such as crushing without insertion, the system may exclude those actions from credit calculation. The final scoring computation may include application of multipliers, station-based weighting, or promotional adjustments. The resulting credit determination is then transmitted to the backend for user notification.

In some embodiments, session termination 622 may also trigger validation checks to detect anomalous behavior. For example, the system may verify that the session duration falls within an expected time range. If the session duration is unusually short or excessively long relative to detected activity, the system may flag the event for review. The system may also compare the number of classified containers against expected behavioral thresholds to identify potential misuse. If irregular patterns are detected, the session may be routed to the human verification module before approval. These safeguards improve fraud resistance and system reliability.

In certain embodiments, once the session has been finalized, the backend system may generate a confirmation message as illustrated in block 624. This confirmation message may include an eligible or non-eligible determination, total number of validated containers, total credits awarded, and any applicable bonuses or adjustments. The confirmation may be displayed within the user application interface and optionally transmitted via push notification, email, SMS, or in-app messaging. If the session is approved, the user's account balance may be updated in real time. If the session is denied or partially approved, the system may provide explanatory feedback and offer a contest pathway.

In some embodiments, user-initiated session termination 622 enhances system flexibility by allowing users to control the duration of the recycling session rather than relying solely on automated timeouts. This user control improves usability and reduces unnecessary idle recording. It also provides a clear temporal boundary for associating container actions with a specific session identifier. By requiring explicit termination, the system reduces ambiguity in credit calculation and improves synchronization between video capture and scoring processes. The termination event thus serves as a critical state transition within the session management architecture, ensuring orderly closure of computational, storage, and validation operations.

In some embodiments, element 638 represents a decision node within the algorithm engine that evaluates the outcome of automated analysis performed on the recorded recycling session. The decision node 638 may receive inputs including classification outputs, confidence scores, deformation verification results, insertion correlation data, timestamp alignment data, and station configuration parameters. The algorithm engine may compute a composite validation score derived from multiple weighted parameters such as container shape conformity, material inference reliability, textual recognition confidence, and successful insertion detection. This composite score may be compared against predefined threshold values to determine whether the recycling event satisfies automatic eligibility criteria. The thresholds may be configurable and may vary depending on station type, campaign rules, or material category. The decision node therefore acts as a structured gating mechanism between automated processing and subsequent workflow stages.

In certain embodiments, the composite validation score evaluated at 638 may be calculated using a probabilistic model, neural network output confidence value, ensemble classifier aggregation, or rule-based scoring system. For example, shape detection may contribute a first weighted score, material inference may contribute a second weighted score, and text or brand detection may contribute a third weighted score. Insertion verification, which confirms that a crushed container was deposited into the appropriate bin aperture within a defined time window, may contribute an additional validation parameter. The system may require that all critical parameters exceed minimum thresholds, or alternatively that a combined aggregate score exceed a predefined cutoff value. This multi-factor scoring mechanism increases robustness against partial occlusion, lighting variation, or temporary camera obstruction. By fusing multiple validation signals, the algorithm engine improves the reliability of automated decisions.

In some embodiments, if the composite score exceeds a high-confidence threshold, the decision node 638 routes the session toward automatic approval, as reflected by the high score path 636. The high-confidence threshold may be defined within a configurable range, such as a confidence probability exceeding 85%, 90%, or 95%, depending on program sensitivity requirements. Sessions meeting this threshold may bypass human verification and proceed directly to credit allocation. This automation reduces operational overhead and improves system scalability. High-confidence approvals may be logged with associated scoring metadata for audit traceability. The system may also record which model version produced the decision for future validation or model improvement.

In certain embodiments, if the composite score falls below a lower confidence threshold, the decision node 638 routes the session toward a lower score branch 642. The lower threshold may represent scenarios where classification certainty is insufficient to justify automatic approval. This may occur in situations involving motion blur, poor lighting, partial container visibility, excessive deformation, or ambiguous insertion timing. In such cases, the system may either deny credit automatically or escalate the session to human verification 610, depending on configurable rules. The routing decision may depend on how far below the threshold the score falls and whether specific validation criteria failed. This branching logic prevents erroneous credit allocation while preserving fairness.

In some embodiments, the decision node 638 may also evaluate contextual parameters beyond classification confidence. For example, the system may analyze session duration, number of containers processed within the session, user historical behavior, or deviation from typical activity patterns. If anomalous behavior is detected, such as unusually high container counts in a short time window, the decision node may override automatic approval even if the classification score is high. The system may then route the session to manual review to ensure integrity. This contextual validation layer enhances fraud prevention and protects the incentive framework. The decision node therefore functions not only as a classifier threshold evaluator but also as a behavioral integrity checkpoint.

In certain embodiments, the decision node 638 may adapt dynamically based on model performance metrics. For example, if real-time analytics indicate increased false-positive rates at a particular station, the system may temporarily increase the approval threshold for that station. Conversely, if human verification consistently confirms high algorithm accuracy, the threshold may be lowered slightly to increase automation efficiency. Threshold adjustments may be managed by the backend configuration system and applied without interrupting active sessions. This adaptive thresholding improves long-term system accuracy and scalability. By incorporating dynamic adjustment capabilities, the decision node supports continuous optimization of automated validation performance.

The decision node 638 therefore represents a core control mechanism within the session processing workflow. It translates raw algorithm outputs into actionable workflow routing decisions. It ensures that automated approvals occur only when sufficient confidence exists while preserving a safeguard pathway for ambiguous or suspicious cases. The structured evaluation at this node improves reliability, reduces false approvals, and enhances system transparency. Through multi-parameter scoring, contextual validation, and configurable thresholds, the algorithm engine decision process strengthens the technical integrity of recycling session verification.

The system provides specific technological improvements to video-based event validation systems by implementing a structured, state-driven session management architecture that governs when image processing is performed and how validation decisions are rendered. Rather than continuously analyzing arbitrary video streams, the system activates processing only upon authenticated session initiation and verified camera readiness. This controlled activation reduces unnecessary computational load and improves processor efficiency. The architecture converts raw video data into structured, session-bounded validation records that are temporally synchronized with user-triggered actions. By constraining analysis within explicit session start and session end states, the system improves temporal correlation between physical actions and algorithmic evaluation. This results in improved reliability and reduced false-positive detections in real-time video processing environments.

The algorithm engine decision node architecture improves automated classification systems by introducing multi-threshold, score-based routing logic. Instead of producing binary outputs directly from a classifier, the system computes a composite validation score derived from multiple independent signals, including crushing detection, insertion verification, geometric conformity, and confidence metrics. The decision node applies configurable threshold ranges that determine whether a session is automatically approved, automatically denied, or escalated to human review. This layered evaluation structure reduces erroneous automation and enhances classification integrity. The use of threshold- based gating prevents low-confidence model outputs from directly triggering irreversible system state changes. As a result, the functioning of machine-learning-driven validation systems is improved through structured control logic that increases determinism, stability, and auditability.

The system further enhances distributed computing performance by separating session orchestration, media ingestion, algorithm processing, and decision rendering into modular subsystems. The backend manages session identifiers and synchronization events, the media server handles stream buffering and segmentation, and algorithm engines operate independently on defined input windows. This separation enables parallel processing and dynamic load balancing across multiple algorithm engines. By preventing analysis of frames outside active sessions, the system reduces processor cycles, memory usage, and network bandwidth consumption. The architecture therefore improves scalability and lowers latency in real-time validation systems. This modular design improves the operation of networked computing systems rather than implementing a generic data- processing workflow.

The inclusion of automated inactivity detection and session timeout logic further improves system resource utilization. Camera heartbeat monitoring and inactivity detection prevent indefinite recording when no user activity is present. This automatic termination mechanism conserves computational resources and reduces unnecessary storage consumption. Time-based session closure ensures that only relevant video segments are analyzed and retained. By dynamically controlling recording duration based on detected activity, the system improves efficiency of media ingestion and storage pipelines. These mechanisms enhance performance and reliability of distributed video- processing environments.

The selective escalation pathway to human verification enhances algorithmic reliability without compromising automation efficiency. The system routes only low-confidence or anomalous sessions to human review while automatically approving high-confidence sessions. This selective routing minimizes redundant reprocessing and reduces unnecessary manual intervention. The structured escalation logic ensures traceable decision pathways and consistent enforcement of validation standards. The architecture balances automation with integrity controls, thereby improving hybrid human-machine validation workflows. The result is increased decision accuracy compared to systems that rely exclusively on either automated or manual review.

The system also improves database functionality and audit traceability by storing session- bounded metadata associated with algorithmic decisions. Each session record includes structured timestamps, confidence scores, threshold evaluations, routing decisions, and final approval outcomes. This structured storage enables reproducible audits and supports model retraining using labeled high- confidence and low-confidence datasets. Retaining contextual decision metadata enhances governance and traceability of machine learning outputs. The database architecture ensures that stored information corresponds to validated physical events rather than unbounded raw input streams. This improves the integrity and analytical usefulness of stored data.

The integrated architecture of session state control, camera readiness verification, composite scoring thresholds, distributed processing, inactivity detection, and selective human escalation provides a specific technical solution to the challenge of reliably validating physical actions through video streams. The system improves computational efficiency, reduces erroneous approvals, enhances scalability, and strengthens fraud resistance. Credit allocation decisions are derived from structured, state-synchronized, hardware-triggered video analysis and threshold-based algorithmic evaluation rather than abstract accounting rules. The improvements are rooted in enhancements to computer vision processing, distributed computing control, and real-time decision gating mechanisms. Accordingly, the claimed subject matter represents a practical technological implementation that improves the functioning of computer systems and video-based validation infrastructure.

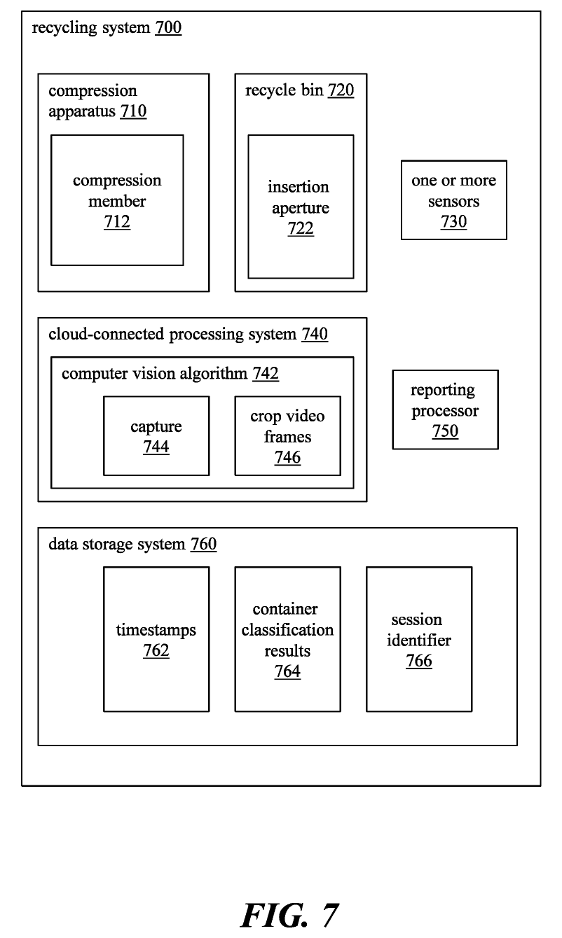

FIG. 7 illustrates a recycling system 700 configured to validate recycling operations involving one or more containers through coordinated mechanical, sensing, processing, and reporting subsystems. The recycling system 700 includes a compression apparatus 710, a recycle bin 720, one or more sensors 730, a cloud-connected processing system 740, a reporting processor 750, and a data storage system 760. The components may be integrated within a single recycling station or distributed across multiple interconnected devices. The system is configured to detect deformation of containers, verify insertion into a recycle bin, classify the containers using computer vision techniques, and record validated recycling events for credit allocation. The architecture supports real-time validation as well as persistent storage of session metadata.

The compression apparatus 710 is configured to receive and deform a container. The compression apparatus 710 includes a compression member 712 that is movable between an open configuration and a closed configuration. In the open configuration, the compression member 712 is positioned to permit insertion of the container into a compression chamber or receiving area. In the closed configuration, the compression member 712 applies compressive force sufficient to deform the container. The compression member 712 may be actuated manually by a lever, handle, or pivoting arm, or may be actuated by a mechanical linkage. The compression apparatus 710 may include structural guides to maintain container alignment during deformation.

The recycle bin 720 includes an insertion aperture 722 configured to receive a deformed container following compression. The insertion aperture 722 may be dimensioned to preferentially accept containers that have undergone deformation while discouraging insertion of undeformed containers. The aperture 722 may include a contoured or tapered geometry designed to accommodate flattened or crushed containers. The recycle bin 720 may be positioned adjacent to or directly below the compression apparatus 710. In some embodiments, the bin may include internal sensors or weight detection mechanisms to confirm successful insertion. The recycle bin 720 therefore functions as a validation zone for completion of the recycling action.

One or more sensors 730 are configured to capture video images of one or more compression operations. The sensors 730 may include one or more cameras positioned to monitor the compression apparatus 710 and the recycle bin 720. The sensors 730 may capture still images, video streams, or sequential image frames. The field of view may include the compression member 712 and the insertion aperture 722 to enable correlation of deformation and disposal actions. In certain embodiments, the sensors 730 may also include position sensors, motion detectors, or proximity sensors configured to detect movement of the compression member 712. The sensor subsystem provides visual data used by the cloud-connected processing system 740.

The cloud-connected processing system 740 includes a computer vision algorithm 742 configured to analyze image data captured by the sensors 730. The computer vision algorithm 742 includes a capture module 744 and a cropping module 746. The capture module 744 may retrieve frames corresponding to the compression event. The algorithm 742 is configured to detect transitions of the compression apparatus 710 from the open configuration to the closed configuration. Upon detecting the transition to the closed configuration, the cropping module 746 isolates one or more cropped image regions corresponding to the compression zone. The cropping process reduces background noise and focuses classification analysis on the region where the container is deformed.

The computer vision algorithm 742 further classifies the cropped image as representing an eligible container, a non-eligible container, or background. The classification may be performed using image recognition techniques, machine learning models, or feature extraction methods. Eligible containers may include containers meeting predefined criteria such as shape, material characteristics, or labeling features. Non-eligible containers may include improperly inserted items, prohibited materials, or foreign objects. The classification result may be accompanied by a confidence score used for validation decisions. The processing system 740 may further correlate classification results with insertion detection at the recycle bin 720.

The reporting processor 750 aggregates validated recycling operations and awards user credits based on a count of such operations. The reporting processor 750 may receive classification results and insertion verification signals from the cloud-connected processing system 740. Upon confirming that a container has been properly deformed and inserted, the reporting processor 750 records a validated recycling event. The reporting processor 750 may calculate credits according to configurable parameters such as container type, quantity, station location, or promotional rules. Credits may be transmitted to a user account associated with the recycling session. The reporting processor 750 may also generate session summaries and usage reports.

The data storage system 760 is configured to store validated recycling event metadata. The data storage system 760 may include structured storage for timestamps 762, container classification results 764, and session identifiers 766. The timestamp data 762 may record the time of compression, insertion, and approval. The container classification results 764 may include classification category, confidence score, and associated cropped image reference. The session identifier 766 uniquely associates a group of recycling events with a specific user session. The data storage system 760 may also retain additional metadata including station identifiers, user identifiers, and algorithm version information.

The data storage system 760 may support long-term analytics and audit functionality. Stored metadata may be used to analyze recycling patterns, station performance, or classification accuracy. The system may further utilize stored data to retrain or refine machine learning models associated with the computer vision algorithm 742. In some embodiments, selected video segments corresponding to validated or disputed events may also be retained for review. The structured storage of session-bounded metadata improves traceability and accountability of recycling credit determinations.

The recycling system 700 therefore integrates mechanical deformation, video capture, state transition detection, image cropping, container classification, insertion verification, reporting logic, and structured data storage. By correlating physical compression events with classified image data and validated insertion actions, the system provides an automated mechanism for confirming recycling compliance. The integration of mechanical apparatus 710, sensor subsystem 730, processing system 740, reporting processor 750, and storage system 760 enables accurate validation and credit allocation for container recycling operations.

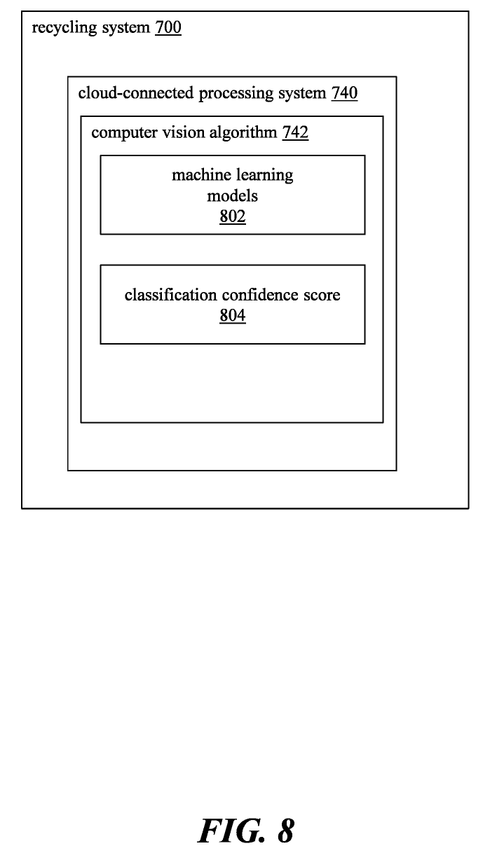

FIG. 8 illustrates a portion of the recycling system 700, focusing on the cloud-connected processing system 740 and, more specifically, the computer vision algorithm 742. The computer vision algorithm 742 comprises one or more machine learning models 802 and is configured to generate a classification confidence score 804 used in automated session decision-making. The architecture shown in FIG. 8 represents a refinement of the processing components previously described, emphasizing algorithmic scoring and validation routing. The system operates on cropped image regions corresponding to the closed configuration of the compression apparatus. The closed configuration represents a state in which the compression member applies compressive force to the container. This state-triggered processing ensures that machine learning inference is temporally synchronized with physical deformation events.

In some embodiments, the computer vision algorithm 742 includes one or more machine learning models 802 configured to process image data derived from one or more cropped image regions. The cropped image regions may be generated by isolating a defined region of interest within frames captured when the compression apparatus transitions to the closed configuration. Cropping may reduce background noise and eliminate irrelevant environmental features. The machine learning models 802 may include convolutional neural networks, deep neural networks, ensemble classifiers, or hybrid feature-based classifiers. The models may be trained using labeled datasets including eligible containers, non-eligible containers, and background images under varied lighting and deformation conditions. By restricting analysis to event-triggered cropped regions, the models operate on data closely associated with container deformation events.

The machine learning models 802 are configured to generate a classification output and a corresponding classification confidence score 804. The classification output may indicate whether the processed image represents an eligible container, a non-eligible container, or background. The classification confidence score 804 may represent a probability value, likelihood metric, weighted aggregate score, or normalized confidence value. In certain embodiments, the confidence score may be calculated based on feature extraction strength, softmax probabilities, ensemble averaging, or weighted model outputs. The confidence score 804 may be stored as part of session metadata and may be used to evaluate the reliability of the classification result. The generation of a confidence score enables structured decision-making rather than binary classification alone.

In some embodiments, the classification confidence score 804 is used to determine automated approval or escalation of a recycling session. The cloud-connected processing system 740 may compare the classification confidence score against one or more predefined thresholds. If the confidence score exceeds a high-confidence threshold, the recycling event may be automatically approved without further review. If the confidence score falls below a defined threshold range, the system may route the recycling session to an escalation path for additional verification. The escalation path may include human review of stored video segments and associated metadata. This threshold- based routing improves validation reliability and reduces erroneous automated approvals.

In certain embodiments, the confidence score 804 may be combined with additional validation parameters prior to final session determination. Such parameters may include detection of insertion of the deformed container into the recycle bin, temporal alignment between compression and insertion events, and confirmation of session activity. The processing system 740 may compute a composite validation score incorporating classification confidence and additional event correlation factors. The composite score may then be evaluated against configurable approval criteria. This layered scoring approach increases robustness under variable lighting, deformation variability, and environmental disturbances. The integration of multi-parameter validation improves system integrity and fraud resistance.

The machine learning models 802 may also be updated over time using stored event metadata and labeled review outcomes. The data storage system may retain classification confidence scores and final approval decisions for retraining purposes. In some embodiments, the models may be periodically retrained to improve accuracy in identifying deformed containers across different material types. The training process may incorporate samples from approved sessions, denied sessions, and escalated sessions reviewed by human verifiers. Continuous refinement of the machine learning models enhances long-term classification performance. The architecture shown in FIG. 8 therefore supports adaptive improvement of automated validation accuracy.

The cloud-connected processing system 740, as shown in FIG. 8, thus integrates machine learning models 802 and classification confidence scoring 804 within a structured approval framework. By operating exclusively on cropped image regions corresponding to the closed configuration of the compression apparatus, the system reduces computational overhead and improves classification relevance. The confidence score 804 provides a quantitative basis for automated routing decisions. This architecture enables scalable, real-time validation of recycling sessions while preserving safeguards through threshold-based escalation mechanisms.

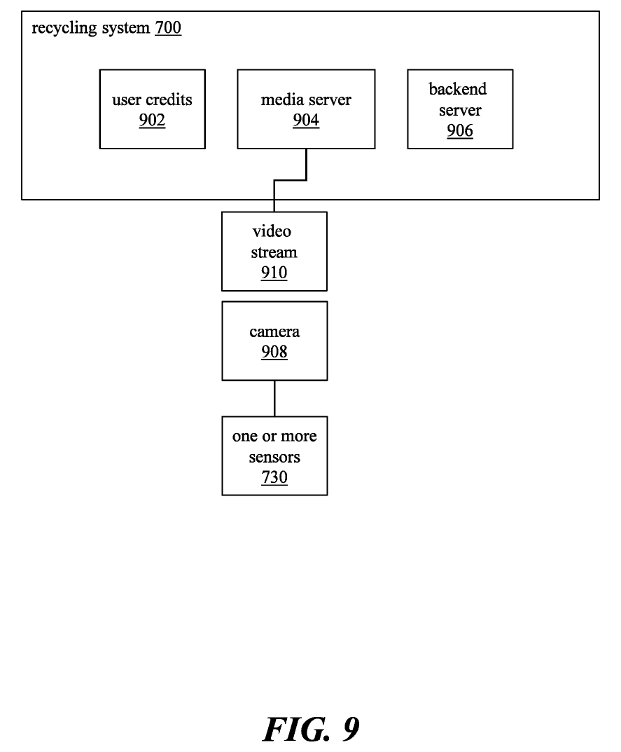

FIG. 9 illustrates an embodiment of recycling system 700 further incorporating session management, streaming infrastructure, and validation routing components. As shown, the recycling system 700 includes one or more sensors 730, a camera 908, a video stream 910, a media server 904, a backend server 906, and a user credits module 902. These components operate in conjunction with the compression apparatus and cloud-connected processing system previously described. The architecture enables coordinated detection of compression movement, live video ingestion, distributed algorithm processing, session lifecycle control, and real-time credit display. The configuration shown in FIG. 9 supports scalable deployment across multiple recycling stations. The system integrates mechanical state detection with network-based processing and user-facing reporting.

In some embodiments, one or more position sensors 730 are integrated with the compression apparatus to detect movement between the open configuration and the closed configuration. The position sensors may include limit switches, magnetic reed switches, optical interrupters, rotary encoders, proximity sensors, or accelerometers. These sensors may generate signals indicating that the compression member has transitioned from an open state permitting container insertion to a closed state applying compressive force. The position sensors may be electrically coupled to the camera 908 and/or the backend server 906 to synchronize state detection with video capture. In certain embodiments, detection of the closed configuration may trigger the capture or tagging of corresponding video frames. The integration of position sensors improves reliability of deformation event detection and reduces false triggering from unrelated motion.

The cloud-connected processing system may be further configured to detect insertion of the deformed container into the recycle bin and correlate the insertion with a corresponding classification result. Insertion detection may be performed using image-based recognition of movement through the insertion aperture, weight sensors within the recycle bin, optical beam interruption sensors, or motion detection algorithms. The system may establish a temporal correlation window during which insertion must occur following deformation. The classification result generated from the cropped image corresponding to the closed configuration may be linked to the detected insertion event using timestamp alignment. Only when both deformation and insertion are confirmed within the defined interval may a recycling event be marked as validated. This correlation mechanism enhances fraud resistance and ensures completion of the recycling process prior to credit allocation.

The reporting processor may be integrated with a user interface configured to display, in real time, a number of validated recycling operations and corresponding credits awarded. The user interface may be implemented within a mobile application, kiosk display, or web-based dashboard. Upon validation of a recycling event, the reporting processor may update the user credits module 902 and transmit updated totals to the interface. The interface may display session-based counts, cumulative credits, material-specific statistics, and reward eligibility indicators. Real-time display functionality provides immediate feedback to the user and confirms successful validation. The reporting processor may further log credit issuance events for audit and analytics purposes.

The backend server 906 is configured to manage initiation and termination of recycling sessions and communication between the sensor 730 and the cloud-connected processing system. Upon receiving a user-initiated session start command, the backend server may generate a unique session identifier and associate the identifier with the active camera stream. The backend server may transmit session control signals to the media server 904 and processing engines to begin recording and analysis. The backend server may also monitor heartbeat signals from the camera 908 and position sensors 730 to confirm system readiness. Session identifiers may be stored in association with timestamps, classification results, and credit outcomes. The backend server therefore orchestrates communication across mechanical, sensing, and processing subsystems.

The media server 904 is configured to receive a live video stream 910 from the camera 908 and transmit the live video stream to one or more algorithm engines for processing. The camera 908 may capture continuous video frames of the compression apparatus and recycle bin during an active session. The media server 904 may perform buffering, encoding, stream segmentation, and distribution of video data. In certain embodiments, multiple algorithm engines may process separate portions of the live video stream in parallel. Parallel processing may reduce latency and improve scalability when multiple recycling stations are active concurrently. Load balancing logic may distribute streams among available processing resources.

The computer vision algorithm may compute a composite validation score based on at least deformation detection, insertion verification, and classification confidence. Deformation detection may be derived from position sensor signals and image-based confirmation of compression. Insertion verification may be derived from aperture monitoring or bin sensor signals. Classification confidence may be generated by one or more machine learning models analyzing cropped image regions. The composite validation score may be calculated using weighted aggregation, probabilistic combination, or rule-based scoring. This composite score provides a quantitative basis for determining session validity.

The composite validation score may be compared against at least one predefined threshold to determine whether a recycling session is automatically approved. A high-confidence threshold may trigger automatic approval and credit issuance without further review. A lower confidence threshold may indicate insufficient certainty for automatic validation. In such cases, the cloud-connected processing system may route sessions having a validation score below the predefined threshold to a human verification module. The threshold values may be configurable and may vary by station type or operational policy.

The human verification module may be configured to review stored video segments and associated classification metadata prior to issuing an eligible or non-eligible decision. The review process may include examination of cropped images, full-session video segments, timestamp logs, and confidence scores. Human reviewers may confirm whether deformation and insertion occurred as required. Based on review, the session may be marked approved or denied, and corresponding credit adjustments may be applied. Review outcomes may be stored for audit and model refinement purposes.

The backend server 906 may further be configured to automatically terminate a recycling session when no user activity is detected for a predetermined time interval. Inactivity detection may be based on absence of position sensor transitions, absence of detected motion within video frames, or expiration of a session timer. Automatic termination prevents indefinite recording and conserves processing and storage resources. Upon termination, the backend server may finalize session metadata and transmit a confirmation message to the user interface. This session management framework ensures efficient resource utilization and controlled lifecycle handling of recycling events. The configuration shown in FIG. 9 therefore integrates mechanical movement detection, insertion correlation, real-time credit reporting, session control, streaming infrastructure, parallel algorithm processing, composite scoring, threshold-based approval, and human verification escalation. By coordinating these subsystems, the recycling system 700 provides structured validation and scalable processing of container recycling operations.

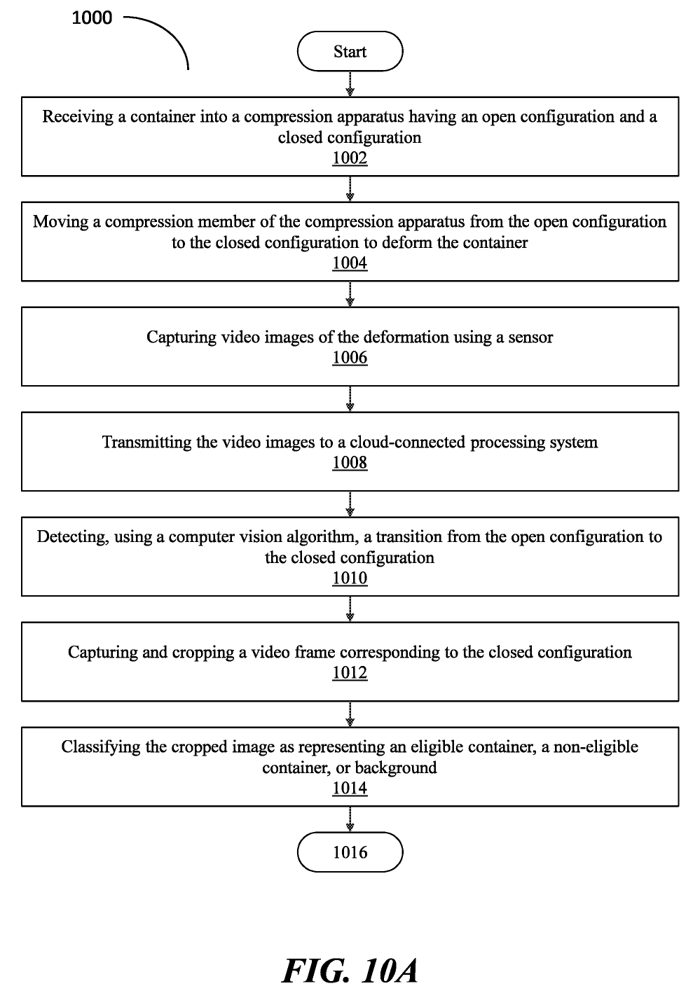

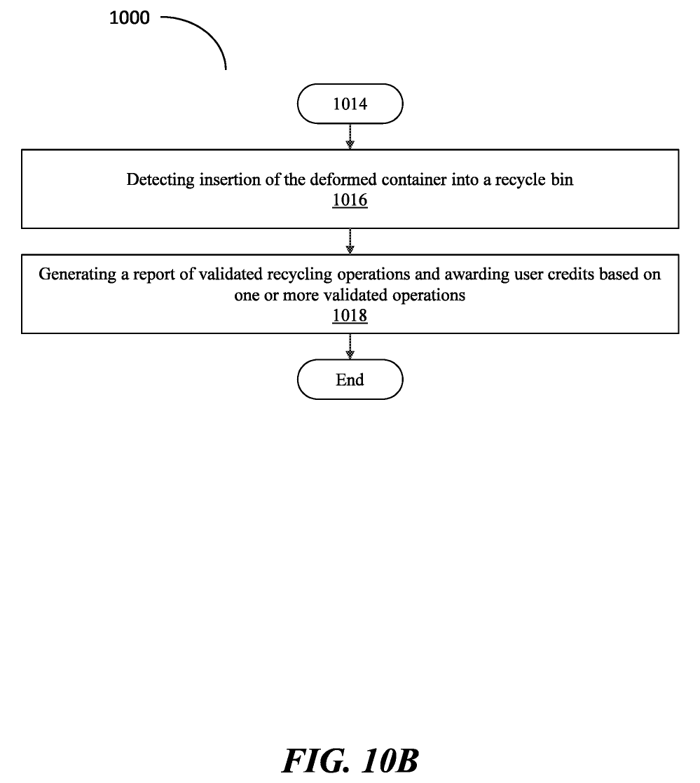

FIGS. 10A and 10B illustrate a method 1000 for recycling one or more containers using coordinated mechanical deformation, video capture, computer vision processing, insertion verification, and credit allocation. The method 1000 may be performed by a recycling system including a compression apparatus, one or more sensors, a cloud-connected processing system, and a reporting processor. The method integrates physical container deformation with event-driven image analysis to validate recycling actions. The sequence shown in FIGS. 10A and 10B represents one exemplary implementation, and certain steps may be reordered or combined without departing from the scope of the method. The method begins at a start state and proceeds through deformation detection, classification, insertion verification, and credit reporting. The steps described below may be executed by one or more processors executing instructions stored in a non-transitory computer- readable medium.

At step 1002, the method includes receiving a container into a compression apparatus having an open configuration and a closed configuration. The open configuration permits insertion of the container into a compression region defined by structural supports or guide surfaces. The container may include a plastic container, metal container, glass container, or other recyclable container. The compression apparatus may include a compression member movable relative to a base or frame. The container may be positioned manually by a user within the compression region. The method may further include verifying that the compression apparatus is in the open configuration prior to insertion.

At step 1004, the method includes moving a compression member of the compression apparatus from the open configuration to the closed configuration to deform the container. Movement of the compression member may be initiated manually through a lever, handle, or pivoting mechanism. Transition to the closed configuration applies compressive force sufficient to deform or flatten the container. The deformation may alter the shape of the container to reduce volume and facilitate insertion into a recycle bin. In some embodiments, one or more position sensors may detect the transition between the open configuration and the closed configuration. The mechanical movement provides a physical event that may be synchronized with video capture.

At step 1006, the method includes capturing video images of the deformation using a sensor. The sensor may include a camera positioned to monitor the compression apparatus and surrounding area. The captured video images may include sequential frames depicting the container before, during, and after deformation. The video stream may be continuous or may be triggered by detection of compression apparatus movement. The field of view may include the compression member and a portion of the recycle bin aperture. Captured frames may be time-stamped to facilitate correlation with subsequent insertion events.

At step 1008, the method includes transmitting the video images to a cloud-connected processing system. The transmission may occur in real time through a media server or communication interface. The video images may be encoded, buffered, and streamed to one or more processing engines. The cloud-connected processing system may associate the transmitted images with a session identifier corresponding to an active recycling session. In some embodiments, video transmission may occur over a wired or wireless network. The processing system prepares the video data for algorithmic analysis.

At step 1010, the method includes detecting, using a computer vision algorithm, a transition from the open configuration to the closed configuration. The algorithm may analyze sequential frames to detect movement of the compression member. Detection may be based on object tracking, edge detection, motion vectors, or sensor-derived signals integrated into the video stream. The transition detection may define a temporal window corresponding to active deformation. This event-driven detection may limit further analysis to frames associated with the closed configuration. The identification of the closed configuration triggers targeted image processing.

At step 1012, the method includes capturing and cropping a video frame corresponding to the closed configuration. The computer vision algorithm may isolate a region of interest within the frame that includes the deformed container. Cropping may reduce background artifacts and eliminate irrelevant environmental elements. The cropped image may include the container and adjacent structural components of the compression apparatus. The cropping operation may be based on predefined geometric coordinates or dynamically detected boundaries. The cropped frame is then prepared for classification processing.

At step 1014, the method includes classifying the cropped image as representing an eligible container, a non-eligible container, or background. Classification may be performed using one or more machine learning models trained to distinguish container types and identify improper objects. The classification process may generate a label and a corresponding confidence score. Eligible containers may include containers meeting predefined criteria such as shape, material properties, or labeling features. Non-eligible containers may include prohibited materials or improperly positioned objects. The classification result may be stored as session metadata.

At step 1016, as illustrated in FIG. 10B, the method includes detecting insertion of the deformed container into a recycle bin. Insertion detection may be performed using image-based recognition of the container passing through an insertion aperture, weight detection within the bin, or optical sensor interruption. The method may correlate insertion timing with the previously detected deformation event. A temporal correlation window may be used to associate deformation and insertion actions. Only when insertion is confirmed may the recycling operation be considered validated. This verification step ensures completion of the recycling cycle.

At step 1018, the method includes generating a report of validated recycling operations and awarding user credits based on one or more validated operations. The reporting process may aggregate classification results and insertion confirmations within a session. Credits may be calculated based on quantity, container type, station parameters, or promotional rules. The report may include timestamps, container classifications, and credit totals. The generated report may be displayed to a user through a user interface. The method then proceeds to an end state, completing the recycling session validation process. The method 1000 therefore integrates mechanical deformation, video capture, transition detection, targeted cropping, classification, insertion verification, and credit reporting within a coordinated workflow. By synchronizing physical state changes with computer vision analysis and insertion confirmation, the method enables automated validation of container recycling actions.

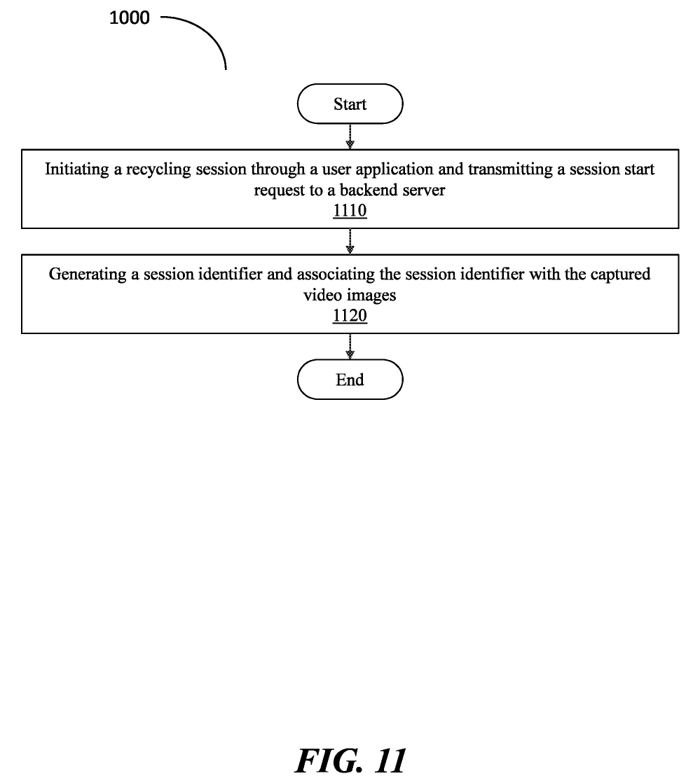

FIG. 11 illustrates an extension of method 1000 incorporating session initiation and session identification processes associated with a user application and backend server. In certain embodiments, prior to performing the container deformation and validation steps described above, a recycling session is initiated through a user application. The user application may be executed on a mobile device, tablet, kiosk interface, or other network-enabled computing device. The initiation process may include placing the mobile device at an appropriate location relative to the recycling station, which may trigger session activation through proximity-based communication such as near- field communication (NFC) or similar mechanisms. The user application may display prompts guiding the user through required recycling steps. Initiating a recycling session establishes a controlled session boundary for subsequent image capture and processing. In some embodiments, the initiation process may include placing the mobile device at an appropriate location relative to the recycling station, which may trigger session activation through proximity-based communication using near-field communication (NFC). NFC refers to a short-range wireless communication technology that enables data exchange between two devices when they are brought within close proximity, such as within a few centimeters. The recycling station may include an NFC tag, NFC sticker, or embedded NFC module that stores station identification data or a session-start token. When the user places the mobile device near the NFC component, the mobile device may automatically read the NFC data and launch or wake the user application. The user application may then transmit a session start request to a backend server and associate the session with a specific station identifier without requiring camera- based code scanning. In certain embodiments, NFC initiation may also trigger activation of the mobile device camera and flashlight to establish a defined capture zone for container processing. This NFC- based initiation improves ease of use and reduces user steps while ensuring the session is reliably linked to the correct physical station.

Upon session initiation, a session start request is transmitted from the user application to a backend server, as illustrated in step 1110 of FIG. 11. The session start request may include user identification information, device identification information, station identification data, and timestamp information. The backend server may verify that the recycling station is operational and that the associated camera or sensor is online. In certain embodiments, the backend server may transmit control signals to activate video capture and processing components and to trigger activation of the mobile device flashlight to illuminate the container processing area. The session start request may also initiate logging processes within the cloud-connected processing system. This communication ensures synchronization between the user application, backend infrastructure, and processing components.

Following receipt of the session start request, the backend server generates a unique session identifier, as illustrated in step 1120 of FIG. 11. The session identifier may be a numeric code, alphanumeric string, universally unique identifier (UUID), or cryptographic token. The session identifier uniquely associates all subsequent deformation, insertion, classification, and credit events with a single recycling session. The identifier may be stored in memory within the backend server and transmitted to the cloud-connected processing system. The session identifier may also be communicated back to the user application for display or confirmation. Generation of a session identifier enables structured tracking and auditability of recycling activity.

In certain embodiments, the generated session identifier is associated with captured video images corresponding to the recycling session. Each captured frame or video segment may be tagged with the session identifier as metadata. The association may occur at the media server level or within the cloud-connected processing system upon receipt of the video stream. The session identifier may be embedded in frame headers, database records, or storage references. Associating the session identifier with video images ensures that classification results and insertion detection events can be accurately attributed to the correct session. This structured association prevents cross-session data contamination.

The session identifier may further be stored within a data storage system along with timestamps, classification results, composite validation scores, and credit issuance records. This stored association enables audit review, dispute resolution, and retraining of machine learning models based on session outcomes. In some embodiments, the backend server may monitor session duration and terminate the session after completion of recycling actions or expiration of a defined inactivity period. Upon termination, the session identifier may be marked as closed, preventing further association with additional video frames. This lifecycle management ensures accurate delimitation of session data.

The session initiation and identification processes illustrated in FIG. 11 enhance traceability, synchronization, and validation integrity of the recycling method. By requiring explicit session initiation through a user application and backend verification, the system prevents unauthorized or untracked video analysis. The generation and association of a unique session identifier with captured video images provides structured data organization and improves reliability of credit allocation. These session management steps integrate with the previously described deformation detection, classification, insertion verification, and reporting operations to provide a comprehensive and auditable recycling validation workflow.

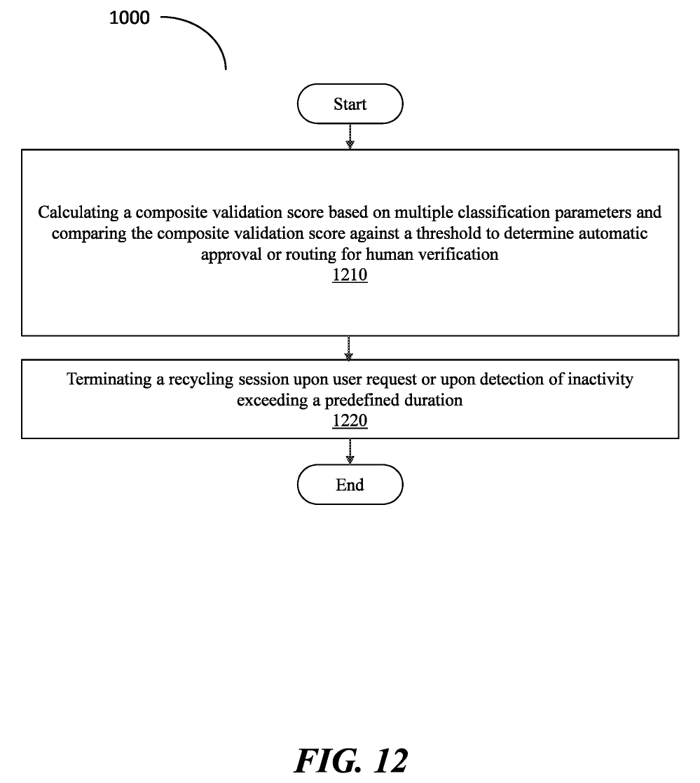

FIG. 12 illustrates an extension of method 1000 incorporating composite validation scoring and session termination logic. In certain embodiments, after classification of a cropped image and detection of insertion of a deformed container into a recycle bin, the method further includes calculating a composite validation score as illustrated in step 1210. The composite validation score may be derived from multiple classification parameters generated during image processing and event correlation. Such parameters may include classification confidence, deformation detection confirmation, insertion verification, timestamp alignment, and sensor-based state confirmation. Each parameter may be assigned a weight reflecting its relative importance to overall validation reliability. The weighted parameters may be aggregated using summation, probabilistic fusion, rule-based evaluation, or other scoring mechanisms to produce a single composite validation score.

In some embodiments, the composite validation score represents a numerical value within a defined range, such as a normalized score between zero and one hundred or a probability value between zero and one. The score may quantify overall confidence that an eligible recycling operation has occurred. The composite validation score may be compared against at least one predefined threshold value. A high threshold may correspond to automatic approval criteria, while a lower threshold may indicate insufficient certainty for automated validation. The threshold values may be configurable based on station configuration, program rules, or operational policies. The comparison process enables structured and consistent decision-making.

If the composite validation score meets or exceeds a predefined approval threshold, the recycling session may be automatically approved without further review. In such embodiments, user credits may be issued immediately and recorded in association with the session identifier. If the composite validation score falls below the threshold, the method may route the recycling session for human verification. Routing for human verification may involve storing associated video segments, cropped image regions, metadata, and scoring parameters for manual review. The human verification process may confirm or override the automated classification result. This threshold-based routing improves system reliability while preserving scalability.

In certain embodiments, the composite validation score may incorporate historical behavioral metrics associated with the user or station. For example, repeated high-confidence validations may increase automation thresholds, while repeated low-confidence outcomes may trigger stricter review policies. The scoring mechanism may dynamically adapt based on stored session metadata and review outcomes. In some embodiments, confidence scores from multiple machine learning models may be combined using ensemble techniques. The composite scoring framework therefore enhances robustness under variable lighting, deformation conditions, and environmental noise.

Following completion of scoring and validation routing, the method may further include terminating the recycling session as illustrated in step 1220. Termination may occur upon explicit user request, such as through selection of a session completion control within a user application. Termination may also occur automatically upon detection of inactivity exceeding a predefined duration. Inactivity detection may be based on absence of position sensor transitions, absence of detected motion within video frames, expiration of a session timer, or lack of insertion events. Automatic termination prevents indefinite video capture and conserves system resources.

Upon termination of the recycling session, the backend server may finalize session metadata and close the associated session identifier. All captured frames, classification results, composite validation scores, and credit issuance data may be consolidated and stored in a data storage system. A confirmation message indicating eligible or non-eligible may be transmitted to the user interface. If the session was routed to human verification, the termination step may mark the session as pending review. The termination process establishes a clear boundary for processing and ensures that subsequent container events are not associated with a closed session.

The steps illustrated in FIG. 12 therefore integrate composite scoring logic with session lifecycle management. By combining multi-parameter validation scoring, threshold-based decision routing, and controlled session termination, the method enhances validation integrity and system efficiency. The structured comparison against configurable thresholds provides consistent automated decision-making. The session termination logic ensures efficient resource utilization and accurate delimitation of recycling events. Together, these processes support scalable and auditable recycling validation operations.

### Examples

Embodiment 1. A recycling system for one or more containers comprising: a compression apparatus configured to receive and deform a container, the compression apparatus comprising a compression member movable between an open configuration permitting insertion of the container and a closed configuration applying compressive force to the container; a recycle bin including an insertion aperture configured to receive a deformed container; a camera configured to capture video images of one or more compression operations; and a cloud-connected processing system including a computer vision algorithm configured to: detect transitions of the compression apparatus from the open configuration to the closed configuration; capture and crop video frames corresponding to the closed configuration; and classify the cropped image as representing an eligible container, a non- eligible container, or background; and a reporting processor configured to aggregate validated recycling operations and award user credits based on a count of such operations.

Embodiment 2. The recycling system of embodiment 1, wherein the computer vision algorithm comprises one or more machine learning models configured to operate on one or more cropped image regions corresponding to the closed configuration of the compression apparatus and to generate a classification confidence score used to determine automated approval or escalation of a recycling session.

Embodiment 3. The recycling system of embodiment 1, further comprising one or more position sensors integrated with the compression apparatus to detect movement between the open configuration and the closed configuration.

Embodiment 4. The recycling system of embodiment 1, wherein the cloud-connected processing system is further configured to detect insertion of the deformed container into the recycle bin and correlate the insertion with a corresponding classification result.

Embodiment 5. The recycling system of embodiment 1, wherein the reporting processor is integrated with a user interface configured to display, in real time, a number of validated recycling operations and corresponding credits awarded.

Embodiment 6. The recycling system of embodiment 1, further comprising a backend server configured to manage initiation and termination of recycling sessions and communication between the camera and the cloud-connected processing system.

Embodiment 7. The recycling system of embodiment 6, further comprising a media server configured to receive a live video stream from the camera and transmit the live video stream to one or more algorithm engines for processing.

Embodiment 8. The recycling system of embodiment 7, wherein the one or more algorithm engines are configured to process separate portions of the live video stream in parallel.

Embodiment 9. The recycling system of embodiment 6, wherein the backend server is configured to generate a unique session identifier upon receiving a user-initiated session start command.

Embodiment 10. The recycling system of embodiment 1, wherein the computer vision algorithm is configured to compute a composite validation score based on at least deformation detection, insertion verification, and classification confidence.

Embodiment 11. The recycling system of embodiment 10, wherein the composite validation score is compared against at least one predefined threshold to determine whether a recycling session is automatically approved.

Embodiment 12. The recycling system of embodiment 11, wherein the cloud-connected processing system is configured to route sessions having a validation score below the predefined threshold to a human verification module.

Embodiment 13. The recycling system of embodiment 12, wherein the human verification module is configured to review stored video segments and associated classification metadata prior to issuing an eligible or non-eligible decision.

Embodiment 14. The recycling system of embodiment 6, wherein the backend server is configured to automatically terminate a recycling session when no user activity is detected for a predetermined time interval.

Embodiment 15. The recycling system of embodiment 1, further comprising a data storage system configured to store validated recycling event metadata including timestamps, container classification results, and session identifiers.

Embodiment 16. A method for recycling one or more containers, comprising: receiving a container into a compression apparatus having an open configuration and a closed configuration; moving a compression member of the compression apparatus from the open configuration to the closed configuration to deform the container; capturing video images of the deformation using a sensor; transmitting the video images to a cloud-connected processing system; detecting, using a computer vision algorithm, a transition from the open configuration to the closed configuration; capturing and cropping a video frame corresponding to the closed configuration; classifying the cropped image as representing an eligible container, a non-eligible container, or background; detecting insertion of the deformed container into a recycle bin; and generating a report of validated recycling operations and awarding user credits based on one or more validated operations.

Embodiment 17. The method of embodiment 16, further comprising initiating a recycling session through a user application and transmitting a session start request to a backend server.

Embodiment 18. The method of embodiment 17, further comprising generating a session identifier and associating the session identifier with the captured video images.

Embodiment 19. The method of embodiment 16, further comprising calculating a composite validation score based on multiple classification parameters and comparing the composite validation score against a threshold to determine automatic approval or routing for human verification.

Embodiment 20. The method of embodiment 19, further comprising terminating a recycling session upon user request or upon detection of inactivity exceeding a predefined duration.

In some aspects, the techniques described herein relate to a recycling system for one or more containers of any recyclable material, such as metal, plastic, and/or glass, including: a manual smashing tool configured to receive and crush a bottle or can, the manual smashing tool configured to be oriented in an open configuration and a closed configuration; a recycle bin featuring an insertion aperture configured to receive smashed material; a camera configured to capture video images of one or more smashing operations; a cloud-connected processing system including a computer vision algorithm to: detect transitions of the manual smashing tool from an open to a closed state; capture and crop video frames corresponding to the closed state of the tool; and classify the cropped image as representing an eligible bottle, an eligible can, a non-eligible bottle, or background; and a reporting processor configured to aggregate validated recycling operations and award user credits based on a count of such operations.

In some aspects, the techniques described herein relate to a recycling system, wherein the computer vision algorithm employs machine learning techniques to enhance the accuracy of a classification process.

In some aspects, the techniques described herein relate to a recycling system, further including mechanical sensors integrated with the manual smashing tool to assist in detecting the open and closed states.

In some aspects, the techniques described herein relate to a recycling system, wherein the processing system is configured to detect a subsequent insertion of a smashed object into the recycle bin and correlate this action with a classification result.

In some aspects, the techniques described herein relate to a recycling system, wherein the reporting processor is integrated with a user interface that displays, in real-time, a number of validated recycling operations and the corresponding credits awarded.

In some aspects, the techniques described herein relate to a method for recycling one or more containers, including the steps of: receiving a bottle or can into a manual smashing tool configured with open and closed states; manually operating the smashing tool to crush the bottle or can; capturing video images of the smashing operation using a camera; transmitting the video images to a cloud- connected processing system; analyzing the video images with a computer vision algorithm to detect a transition from the open to the closed state of the smashing tool; capturing and cropping a video frame corresponding to the closed state; classifying the cropped image as representing an eligible bottle, an eligible can, a non-eligible bottle, or background; detecting an insertion of a smashed object into a recycle bin; and generating a report of validated recycling operations and awarding user credits based on a number of one or more operations.

In some aspects, the techniques described herein relate to a method, further including the step of displaying the generated report on a user interface.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software may include the instructions and certain data that, when executed by the one or more processors, manipulate the one or more processors to perform one or more aspects of the techniques described above. The non-transitory computer-readable storage medium may include, for example, a magnetic or optical disk storage device, solid-state storage devices such as Flash memory, a cache, random access memory (RAM) or other non-volatile memory device or devices, and the like. The executable instructions stored on the non-transitory computer- readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media may include, but are not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non- volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network-accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes may be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A recycling system for one or more containers comprising:a compression apparatus configured to receive and deform a container, the compression
apparatus comprising a compression member movable between an open configuration permitting insertion of the container and a closed configuration configured to apply compressive force to the container;a recycle bin including an insertion aperture configured to receive a deformed container;a sensor configured to capture video images of one or more compression operations; anda cloud-connected processing system including a computer vision algorithm configured to:detect transitions of the compression apparatus from the open configuration to the closed configuration;capture and crop video frames corresponding to the closed configuration; andclassify the cropped image as representing an eligible container, a non-eligible container, or background; anda reporting processor configured to aggregate validated recycling operations and award user credits based on a count of such operations.

2. The recycling system of claim 1, wherein the computer vision algorithm comprises one or more machine learning models configured to operate on one or more cropped image regions corresponding to the closed configuration of the compression apparatus and to generate a classification confidence score used to determine automated approval or escalation of a recycling session.

3. The recycling system of claim 1, further comprising one or more position sensors integrated with the compression apparatus to detect movement between the open configuration and the closed configuration.

4. The recycling system of claim 1, wherein the cloud-connected processing system is further configured to detect insertion of the deformed container into the recycle bin and correlate the insertion with a corresponding classification result.

5. The recycling system of claim 1, wherein the reporting processor is integrated with a user interface configured to display, in real time, a number of validated recycling operations and corresponding credits awarded.

6. The recycling system of claim 1, further comprising a backend server configured to manage initiation and termination of recycling sessions and communication between the sensor and the cloud-connected processing system.

7. The recycling system of claim 6, further comprising a media server configured to receive a live video stream from the sensor and transmit the live video stream to one or more algorithm engines for processing.

8. The recycling system of claim 7, wherein the one or more algorithm engines are configured to process separate portions of the live video stream in parallel.

9. The recycling system of claim 6, wherein the backend server is configured to generate a unique session identifier upon receiving a user-initiated session start command.

10. The recycling system of claim 1, wherein the computer vision algorithm is configured to compute a composite validation score based on at least deformation detection, insertion verification, and classification confidence.

11. The recycling system of claim 10, wherein the composite validation score is compared against at least one predefined threshold to determine whether a recycling session is automatically approved.

12. The recycling system of claim 11, wherein the cloud-connected processing system is configured to route sessions having a validation score below the predefined threshold to a human verification module.

13. The recycling system of claim 12, wherein the human verification module is configured to review stored video segments and associated classification metadata prior to issuing an eligible or non-eligible decision.

14. The recycling system of claim 6, wherein the backend server is configured to automatically terminate a recycling session when no user activity is detected for a predetermined time interval.

15. The recycling system of claim 1, further comprising a data storage system configured to store validated recycling event metadata, including timestamps, container classification results, andsession identifiers.

16. A method for recycling one or more containers, comprising:receiving a container into a compression apparatus having an open configuration and a closed configuration;moving a compression member of the compression apparatus from the open configuration to the closed configuration to deform the container;capturing video images of the deformation using a sensor;transmitting the video images to a cloud-connected processing system;detecting, using a computer vision algorithm, a transition from the open configuration to the closed configuration;capturing and cropping a video frame corresponding to the closed configuration;classifying the cropped image as representing an eligible container, a non-eligible container, or background;detecting insertion of the deformed container into a recycle bin; and generating a report of validated recycling operations and awarding user credits based on one or more validated operations.

17. The method of claim 16, further comprising initiating a recycling session through a user application and transmitting a session start request to a backend server.

18. The method of claim 17, further comprising generating a session identifier and associating the session identifier with the captured video images.

19. The method of claim 16, further comprising calculating a composite validation score based on multiple classification parameters and comparing the composite validation score against a threshold to determine automatic approval or routing for human verification.

20. The method of claim 19, further comprising terminating a recycling session upon user request or upon detection of inactivity exceeding a predefined duration.
